SEQUENCE LISTING (10 sequences)

SEQ ID NO: 1 - RNA, 22 nt, Homo sapiens
ugagguaguagguuguauaguu

SEQ ID NO: 2 - RNA, 22 nt, Homo sapiens
agaccugaauaccacuuaccuc

SEQ ID NO: 3 - RNA, 22 nt, Homo sapiens
cacuacucaaaauacuaccucu

SEQ ID NO: 4 - RNA, 22 nt, Homo sapiens
uacccuccaagucuguaccuca

SEQ ID NO: 5 - RNA, 22 nt, Homo sapiens
gacuuugcaaagaccuaccucc

SEQ ID NO: 6 - RNA, 22 nt, Homo sapiens
guuucaaaggccacauaccucu

SEQ ID NO: 7 - RNA, 22 nt, Homo sapiens
aucaaaacacacuacuaccucu

SEQ ID NO: 8 - RNA, 22 nt, Homo sapiens
aacuaugcaaccuacuaccucu

SEQ ID NO: 9 - RNA, 22 nt, Homo sapiens
ccagcguaccaagcagcaagag

SEQ ID NO: 10 - RNA, 22 nt, Homo sapiens
uugauacguuggaugauggaga

(19) United States
(12) Patent Application Publication
(10) Pub. No.: US 2013/0046528 A1
(43) Pub. Date: Feb. 21, 2013

(54) CRYPTOGRAPHIC APPROACH TO MICRORNA TARGET BINDING ANALYSIS

(71) Applicant: HARRY C. SHAW, BEL AIR, MD (US)

(72) Inventor: HARRY C. SHAW, BEL AIR, MD (US)

(21) Appl. No.: 13/534,427

(22) Filed: Jun. 27, 2012

Related U.S. Application Data
(63) Continuation-in-part of application No. 13/211,432, filed on Aug. 17, 2011.

(51) Int. Cl. G06F 19/00; G06F 19/12

(52) U.S. Cl. 703/11

(57) ABSTRACT

A cryptographic approach to miRNA:mRNA binding analysis is presented. Coded miRNA and mRNA sequences may be split into a plurality of subsequences and encrypted using an encryption algorithm. The encrypted subsequences may then be decrypted, analyzed using vector analysis, evaluated, and scored accordingly.

### CROSS-REFERENCE TO RELATED APPLICATION

This application is a continuation-in-part of, and claims priority to, U.S. patent application Ser. No. 13/211,432, filed on Aug. 17, 2011. The subject matter of the earlier filed application is hereby incorporated by reference in its entirety.

### ORIGIN OF THE INVENTION

The invention described herein was made by an employee of the United States Government and may be manufactured and used by or for the Government for Government purposes without the payment of any royalties thereon or therefore.

### FIELD

The present invention generally relates to modeling, and more particularly, to modeling micro-ribonucleic acid (“miRNA”) and messenger RNA (“mRNA”) interactions.

### BACKGROUND

miRNA is part of a class of short RNA sequences that do not code for proteins. However, such “non-coding” RNA may regulate gene expression of deoxyribonucleic acid (“DNA”). Therapies based on non-coding RNA, such as miRNA, have the potential to revolutionize therapies for a wide range of diseases. For instance, miRNA has been shown to delay cell division, and thus act as a tumor suppressor, in cancer. miRNA is involved in a wide range of cellular regulatory mechanisms, some of which are believed to have not yet been discovered. miRNA regulatory networks include pathways that affect pre- and post-transcriptional regulation of gene expression and chromatin remodeling. miRNA can regulate the amount of mRNA produced in a cell. Tumor types can possess a specific “expression profile” of miRNA that opens the possibility of a certainty diagnosis for the tumor type and implicitly, for the application of adequate therapy. Regarding viral cancers, the pathogenic capacity of viruses may be related to their capacity to affect cellular miRNA.

miRNA is composed of relatively short sequences of RNA that are generally between 18-25 nucleotides long. For instance, the mature human miRNA sequence hsa-let-7a is UGAGGUAGUAGGUUGUAUAGUU. miRNA begins as a gene transcription product in the nucleus and is truncated and transported to the cell cytoplasm, where the miRNA has the opportunity to bind to mRNA and upregulate or downregulate protein expression.

More specifically, miRNA is transcribed primarily by RNA Polymerase II into primary RNA transcript (“pri-miRNA”) with a cap and a poly-A tail (having multiple adenosine bases). A microprocessor complex (Drosha-RNAse III family and Pasha dsRNA binding domain) processes the pri-miRNA transcript to form stem-loop pre-miRNA. Exportin 5 transports pre-miRNA to the cytoplasm via nuclear core complex proteinaceous channels embedded in the nuclear membrane. Dicer (RNAase III) cleaves the pre-miRNA complex into miRNA:miRNA duplex. miRNA Helicase unwinds the miRNA:miRNA duplex. Finally, a guide strand of miRNA complexes with RNA Induced Silencing Complex (“RISC”) and binds to mRNA. The degree of complementarity is thought to dictate the modality of representation (i.e., translational repression for partial complements or mRNA degradation for perfect complements).

However, there are various problems that have prevented miRNA therapies from flourishing to date. It is known that sequence information alone is insufficient to predict miRNA:mRNA regulation. A single miRNA can regulate expression of many mRNAs and a single mRNA can be regulated by many miRNAs. The presence of the seed-target matches does not guarantee downregulation of mRNA. There are structural considerations, such as single or double strandedness of the miRNA and protein binding domain interaction with miRNA, which are factors in successful miRNA translational regulation. Both cis- and trans-regulatory effects exist in miRNA regulation, as well as cooperative binding effects on multiple miRNAs, amplifying the regulation of an mRNA target. Location of the target within the 3′ untranslated region (“UTR”) of the mRNA is a factor, but the target sequence can appear within an open reading frame (“ORF”), and appearance of the target within the 3′ UTR is not a necessary and sufficient condition for mRNA regulation. In addition to the above factors, two types of regulation are observed: endonucleolytic cleavage and translational repression. miRNA binding can cause mRNA to be cleaved near the target site, completely eliminating translational expression.

The mechanisms that determine specificity are not currently fully understood. Furthermore, the short sequences of miRNA and the four letter RNA alphabet (A, C, U, G) provide a limited number of combinations of miRNA sequences relative to compounds capable of having longer chains, such as DNA. Also, miRNA binds to mRNA with a suitable target sequence having 6-8 bases. As such, between 4⁶=4096 and 4⁸=65536 combinations are possible. This translates into a broad pattern of regulation. In other words, one miRNA sequence can regulate many mRNA sequences, and one mRNA sequence can be regulated by many miRNA sequences. This leads to the risk of unintended outcomes. The ultimate goal is to utilize miRNA to target specific products of gene expression, but first it should be understood how and why miRNA targets some mRNA sequences and not others, as well as what interactions are important.

miRNA:mRNA target modeling is a growing field in academia and industry. Developers of miRNA therapies desire tools that give them a proprietary development edge. Accordingly, miRNA modeling that predicts and understands how miRNA performs regulation processes may be beneficial.

### SUMMARY

Certain embodiments of the present invention may provide solutions to the problems and needs in the art that have not yet been fully identified, appreciated, or solved by current miRNA modeling technologies. For example, some embodiments of the present invention apply a cryptographic approach to miRNA:mRNA binding analysis.

In one embodiment, an apparatus includes a processor and memory storing computer program instructions. The computer program instructions are configured to cause the processor to generate channel codes, such as Hamming codes, for RNA bases and code miRNA sequences and mRNA sequences using the channel codes.

In another embodiment, a computer-implemented method is performed by a physical computing device. The physical computing device may be a desktop or laptop computer, a server, a database, a personal digital assistant (“PDA”), a cell phone, a tablet computer, a distributed system, a cloud computing system, or any computing device or combination of computing devices, as would be understood by one of ordinary skill in the art. The computer-implemented method includes generating, by a processor, channel codes, such as Hamming codes, for RNA bases. The computer-implemented method also includes coding, by the processor, miRNA sequences and mRNA sequences using the generated channel codes.

In yet another embodiment, a computer-implemented method includes decrypting, by a processor, a plurality of encrypted miRNA and mRNA subsequences.

### BRIEF DESCRIPTION OF THE DRAWINGS

For a proper understanding of the invention, reference should be made to the accompanying figures. These figures depict only some embodiments of the invention and are not limiting of the scope of the invention. Regarding the figures:

FIG. 1 illustrates the casting of lacZ operon expression in terms of an authentication and confidentiality problem, according to an embodiment of the present invention.

FIG. 2 illustrates a simplified miRNA regulation pathway.

FIG. 3 illustrates RNAi silencing through Ago2 binding with a guide strand and a target strand.

FIG. 4 illustrates the RSA methodology.

FIG. 5 illustrates keys used for RSA decryption and detuning, according to an embodiment of the present invention.

FIG. 6 illustrates the construction of a secondary structure source code from a secondary structure codebook (database) for an RNA sequence that is single-stranded, according to an embodiment of the present invention.

FIG. 7 illustrates the construction of a secondary structure source code from the secondary structure codebook (database) for an RNA sequence that is folded and contains Watson-Crick and guanine-adenine wobble pairs, according to an embodiment of the present invention.

FIG. 8 illustrates the coding phase of the modeling process, according to an embodiment of the present invention.

FIG. 9 illustrates the encryption phase of the modeling process, according to an embodiment of the present invention.

FIG. 10 illustrates the decryption and detuning phase of the modeling process, according to an embodiment of the present invention

FIG. 11 illustrates the vector projection phase of the modeling process, according to an embodiment of the present invention

FIG. 12 illustrates the organization of the output data after completion of the vector projection phase of the modeling process, according to an embodiment of the present invention.

FIG. 13 illustrates error projections of base pair position 1 in HMGA2-1091 onto let-7d, let-7d comp, and let-7d anti, according to an embodiment of the present invention.

FIG. 14 illustrates the geometry associated with the variables E1, E2, E3, F, c1, c2, c3, θ, θ₁, θ₂, φ, and ρ for c1>c2>c3, all positive, according to an embodiment of the present invention.

FIG. 15 illustrates the geometry associated with the variables E1, E2, E3, F, c1, c2, c3, θ, θ₁, θ₂, φ, and ρ for c1>c2>c3, c3<0, according to an embodiment of the present invention.

FIG. 16 illustrates the geometry associated with the variables E1, E2, E3, F, c1, c2, c3, θ, θ₁, θ₂, φ, and ρ for c1>c2>c3, c2<0, c3<0, according to an embodiment of the present invention.

FIG. 17 illustrates the geometry associated with the variables E1, E2, E3, F, c1, c2, c3, θ, θ₁, θ₂, φ, and ρ for c1>c2>c3, c1<0, c2<0, c3<0, according to an embodiment of the present invention.

FIG. 18 illustrates the geometry associated with the variables E1, E2, E3, F, c1, c2, c3, θ, θ₁, θ₂, φ, and ρ for c1>c3>c2, all positive, according to an embodiment of the present invention.

FIG. 19 illustrates the geometry associated with the variables E1, E2, E3, F, c1, c2, c3, θ, θ₁, θ₂, φ, and ρ for c1>c3>c2, c2<0, according to an embodiment of the present invention.

FIG. 20 illustrates the geometry associated with the variables E1, E2, E3, F, c1, c2, c3, θ, θ₁, θ₂, φ, and ρ for c1>c3>c2, c3<0, c2<0, according to an embodiment of the present invention.

FIG. 21 illustrates the geometry associated with the variables E1, E2, E3, F, c1, c2, c3, θ, θ₁, θ₂, φ, and ρ for c1>c3>c2, c1<0, c3<0, c2<0, according to an embodiment of the present invention.

FIG. 22 illustrates the geometry associated with the variables E1, E2, E3, F, c1, c2, c3, θ, θ₁, θ₂, φ, and ρ for c2>c1>c3, all positive, according to an embodiment of the present invention.

FIG. 23 illustrates the geometry associated with the variables E1, E2, E3, F, c1, c2, c3, θ, θ₁, θ₂, φ, and ρ for c2>c1>c3, c3<0, according to an embodiment of the present invention.

FIG. 24 illustrates the geometry associated with the variables E1, E2, E3, F, c1, c2, c3, θ, θ₁, θ₂, φ, and ρ for c2>c1>c3, c1<0, c3<0, according to an embodiment of the present invention.

FIG. 25 illustrates the geometry associated with the variables E1, E2, E3, F, c1, c2, c3, θ, θ₁, θ₂, φ, and ρ for c2>c1>c3, c2<0, c1<0, c3<0, according to an embodiment of the present invention.

FIG. 26 illustrates the geometry associated with the variables E1, E2, E3, F, c1, c2, c3, θ, θ₁, θ₂, φ, and ρ for c2>c3>c1, all positive, according to an embodiment of the present invention.

FIG. 27 illustrates the geometry associated with the variables E1, E2, E3, F, c1, c2, c3, θ, θ₁, θ₂, φ, and ρ for c2>c3>c1, c1<0, according to an embodiment of the present invention.

FIG. 28 illustrates the geometry associated with the variables E1, E2, E3, F, c1, c2, c3, θ, θ₁, θ₂, φ, and ρ for c2>c3>c1, c3<0, c1<0, according to an embodiment of the present invention.

FIG. 29 illustrates the geometry associated with the variables E1, E2, E3, F, c1, c2, c3, θ, θ₁, θ₂, φ, and ρ for c2>c3>c1, c2<0, c3<0, c1<0, according to an embodiment of the preset invention.

FIG. 30 illustrates the geometry associated with the variables E1, E2, E3, F, c1, c2, c3, θ, θ₁, θ₂, φ and ρ for c3>c1>c2, all positive, according to an embodiment of the present invention.

FIG. 31 illustrates the geometry associated with the variables E1, E2, E3, F, c1, c2, c3, θ, θ₁, θ₂, φ, and ρ for c3>c1>c2, c2<0, according to an embodiment of the present invention

FIG. 32 illustrates the geometry associated with the variables E1, E2, E3, F, c1, c2, c3, θ, θ₁, θ₂, φ and ρ for c3>c1>c2, c1<0, c2<0, according to an embodiment of the present invention.

FIG. 33 illustrates the geometry associated with the variables E1, E2, E3, F, c1, c2, c3, θ, θ₁, θ₂, φ, and ρ for c3>c1>c2, c3<0, c1<0, c2<0, according to an embodiment of the present invention.

FIG. 34 illustrates the geometry associated with the variables E1, E2, E3, F, c1, c2, c3, θ, θ₁, θ₂, φ, and ρ for c3>c2>c1, all positive, according to an embodiment of the present invention.

FIG. 35 illustrates the geometry associated with the variables E1, E2, E3, F, c1, c2, c3, θ, θ₁, θ₂, φ, and ρ for c3>c2>c1, c1<0, according to an embodiment of the present invention.

FIG. 36 illustrates the geometry associated with the variables E1, E2, E3, F, c1, c2, c3, θ, θ₁, θ₂, φ, and ρ for c3>c2>c1, c2<0, c1<0, according to an embodiment of the present invention.

FIG. 37 illustrates the geometry associated with the variables E1, E2, E3, F, c1, c2, c3, θ, θ₁, θ₂, φ, and ρ for c3>c2>c1, c3<0, c2<0, c1<0, according to an embodiment of the present invention.

FIG. 38 illustrates the selection of a secondary structure from a local neighborhood of secondary structure codes with the size of the neighborhood defined by a confidence interval of 10 adjacent codes, according to an embodiment of the present invention.

FIG. 39 is a programming example of a miRNA and mRNA sequence with only single-stranded secondary structure codes, according to an embodiment of the present invention.

FIG. 40 illustrates a 132×13 scoring matrix A for SVD analysis, according to an embodiment of the present invention.

FIG. 41 illustrates the scoring output for a summary prediction of downregulation behavior of 6 mRNAs onto let-7d for scoring factor f=0.25 and f=1, according to an embodiment of the present invention.

FIG. 42 illustrates communications model of multiple miRNA; mRNA interactions, according to an embodiment of the present invention.

FIG. 43 illustrates a computing system, according to an embodiment of the present invention.

### DETAILED DESCRIPTION OF THE EMBODIMENTS

It will be readily understood that the components of the present invention, as generally described and illustrated in the figures herein, may be arranged and designed in a wide variety of different configurations. Thus, the following detailed description of the embodiments of apparatuses, systems, methods, and computer readable media, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Key Terms

Gene Expression: The process by which gene sequences deliver products, whether the products are proteins or types of RNA.

RNA Interference: Processes that prevent mRNA transcribed from DNA in the cell nucleus and transported from the nucleus to the cytoplasm from being translated into products.

Downregulation: Suppression of gene expression.

Upregulation: Enhancement of gene expression. Downregulation of one product can induce upregulation of another product, and vice versa.

Secondary Structure: Structure resulting from folding and looping of the RNA sequence.

The many-to-many relationship between miRNA and mRNA has created a demand for accurate modeling tools to predict miRNA:mRNA seed-target binding. Some embodiments of the present invention provide predictive and accurate modeling pertaining to how miRNA performs regulation processes. More specifically, the modeling of some embodiments narrows down the miRNA:mRNA interactions to a tractable number that can be investigated in the laboratory. The interaction of miRNA and mRNA may be modeled using source and channel coding models.

Biomolecular systems of gene expression “authenticate” themselves through various means, such as transcription factors and promoter sequences. Biomolecular systems have means of retaining “confidentiality” of the meaning of genome sequences through processes such as control of protein expression. Factors such as regulation of gene expression can be modeled utilizing the concepts from public key infrastructure (“PKI”). Once problems have been cast in this form, as uniquely identified and applied in at least some embodiments, the appropriate tools from cryptography and communications systems analysis can be leveraged to perform a variety of analyses and predictions. Advantages of this approach include the ability to target a wide range of problems with a small number of commercially available tools by applying embodiments of the present invention, carefully calibrate the results, and develop temporal domain models in place of static models. The merging of processes from the information security domain with analysis of problems from the molecular biology domain provides a new process of molecular cryptography that can provide benefits to solving problems in both domains.

The process of encryption and decryption can be used to accommodate uncertainty and lack of complete information with regards to biochemical pathways. Unknown information that would be key to creating an accurate physics-based model can be accommodated in a cryptographic model. Whereas the physics-based model makes simplifications for accommodations, the cryptographic model may incorporate that uncertainty in the coding process. The cryptographic process may allow for wide differentiation between objects that appear to be similar or identical. In the case of miRNA, two similar sequences of 22 bases may have drastically different patterns of post-transcriptional regulation of mRNA expression. By using techniques from coding theory, identical genomic or proteomic sequences can be differentiated using specific coding for secondary or tertiary structure. The cryptographic process may permit a hierarchy of coding such that an iterative process of encryption and decryption can be performed. New information about a process can be incorporated by expanding the model.

The following primary sequences in Table 1 were used for some embodiments. In cases of conflicts between source materials on the primary sequence, the sequences may be resolved as shown in Table 1. All sequences may be truncated to 22 bases in some embodiments.

TABLE 1
REFERENCE mRNA AND miRNA SEQUENCES

| | |
|---|---|
| HMGA2_1091 | AGACCUGAAUACCACUUACCUC |
| HMGA2_1244 | CACUACUCAAAAUACUACCUCU |
| HMGA2 1604 | UACCCUCCAAGUCUGUACCUCA |
| HMGA2_1655 | GACUUUGCAAAGACCUACCUCC |
| HMGA2_2213 | GUUUCAAAGGCCACAUACCUCU |
| HMGA2_2507 | AUCAAAACACACUACUACCUCU |
| let-7d | UUGAUACGUUGGAUGAUGGAGA |
| let_7d_comp | AACUAUGCAACCUACUACCUCU |
| let_7d_anti | CCAGCGUACCAAGCAGCAAGAG |

HMGA2 is a high-mobility group protein and is oncogenic in a variety of tumors, including benign mesenchymal tumors and certain lung cancers. The designations of 1091, 1244, 1604, 1655, 2213, and 2507 refer to the starting base position from the 5′ end. Therefore, in the case of HMGA2-1091, the let-7d sequence is generally matched against the HMGA2 mRNA sequence starting at position 1091 from the 5′ end. Data used in this example can be compared directly against data from sources such as http://www.microrna.org, for example. miRNA sequence let-7d is the miRNA sequence under evaluation in some embodiments. Calibration sequences let_{—}7d_comp (Watson-Crick match of let-7d at every position) and let_{—}7d_anti (Watson-Crick mismatch of let-7d at every position) may also be used.

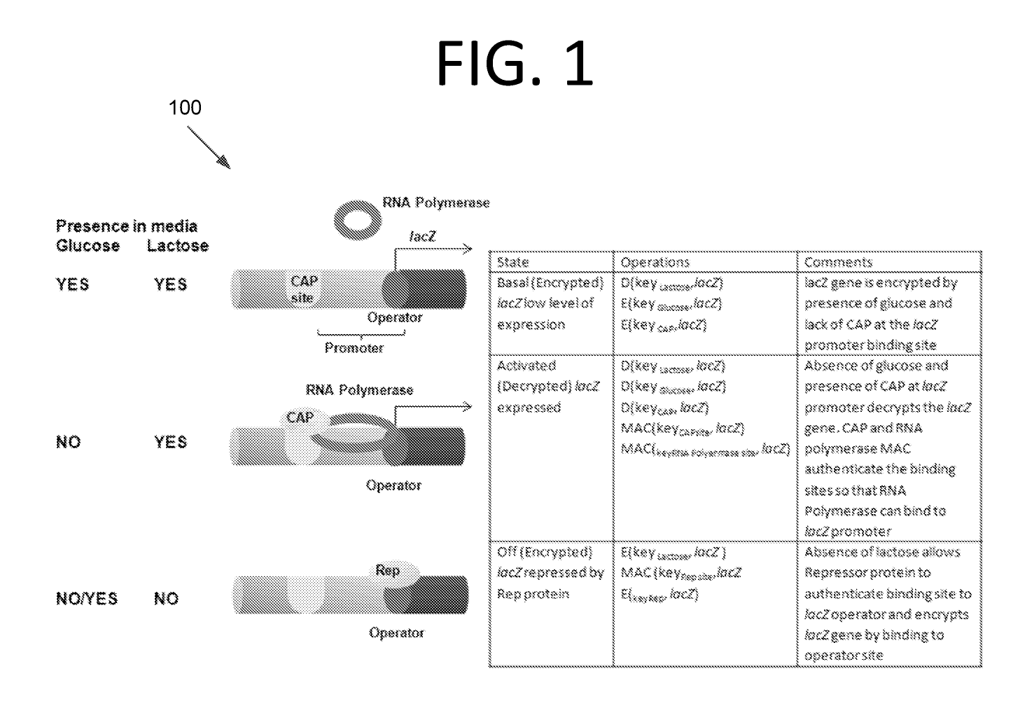

FIG. 1 provides an example 100 of the casting of lacZ operon expression in terms of an authentication problem, according to an embodiment of the present invention. In this prokaryotic example from E. coli, the lacZ gene expresses the β-galactosidase enzyme when lactose is present and the simple sugar glucose is absent. β-galactosidase metabolizes lactose into glucose and galactose. It would be inefficient to express the enzyme above a trace level if glucose is present.

FIG. 1 provides a cryptographic analogy to the states of the lacZ gene under the various conditions, including both glucose and lactose being present, only lactose being present, and lactose being absent. The lacZ gene is encrypted when lactose is absent or both lactose and glucose are present. A repressor protein (rep) authenticates (binds) to the encryption site (lacZ operator) on the lacZ gene when lactose is absent. A catabolite activator protein (“CAP”) authenticates (binds) to the decryption site (CAP site) allowing RNA polymerase to decrypt (express) the lacZ gene when glucose is absent.

All of these operations are shown as analogies to elements of cryptographic message traffic in the operations shown in FIG. 1. It is possible to write the description of the gene expression sequence in FIG. 1 in terms of a series of messages between a sender and a receiver. One major advantage of this approach is that a properly operating authentication process may incorporate all of the behavior of the system, including behavior that is currently not well understood or modeled. This includes accurate knowledge of all relevant steric and electrostatic forces, concentration dependencies, and understanding of all relevant molecular interactions (protein-to-protein, nucleic acid-to-nucleic acid, protein-to-nucleic acid, etc.). In some embodiments, a specific implementation of the protocol only includes the miRNA-to-mRNA interaction. The extensible nature of the model allows for adding details, such as RISC-miRNA coding, as an enhancement.

In some embodiments, the model operates statically in time. More specifically, a static model is a model of miRNA:mRNA interaction at a fixed snapshot in time with a fixed set of secondary structure codes and public/private key pairs. However, proteins and nucleic acids exhibit dynamic features in time. Proteins and nucleic acids exhibit folding and looping behavior, associations and disassociations, etc. Therefore, in some embodiments, the model operates dynamically in time by allowing miRNA:mRNA interaction to be modeled over variations in time. For example, a sequence of secondary structures over time can be attributed to miRNA and mRNA sequences to be modeled and analyzed.

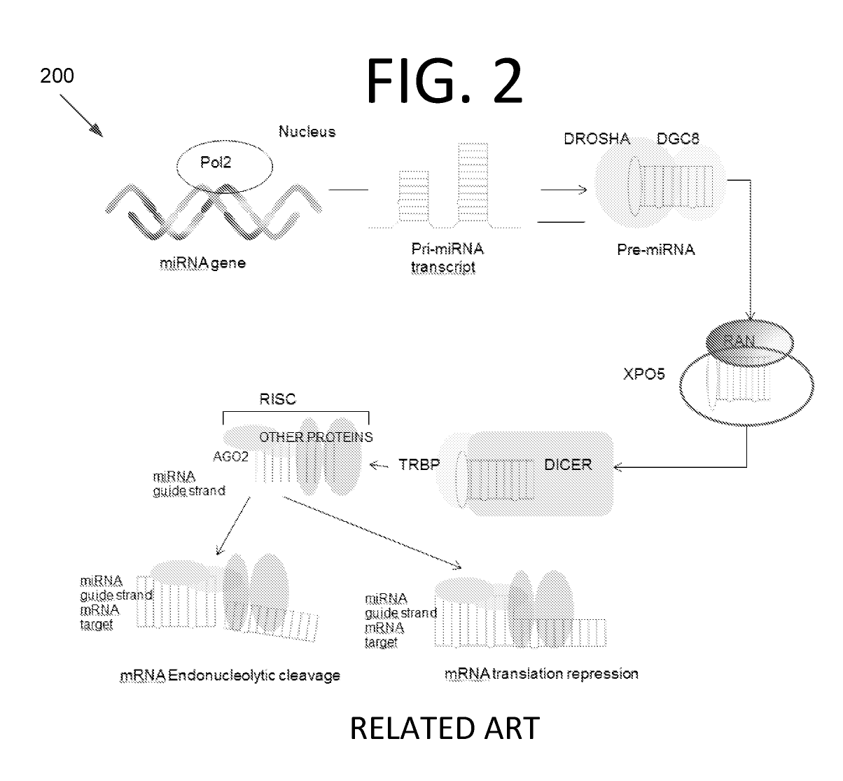

FIG. 2 illustrates a simplified miRNA regulation pathway 200. The miRNA gene is transcribed by RNA Polymerase II to produce pri-miRNA transcript. Due to its charged nature, RNA is never found free. Rather, RNA is always complexed with a protein. The pri-miRNA transcript is processed by a complex of DROSHA and DGC8 proteins to a ds-miRNA hairpin pre-miRNA transcript. The pre-miRNA transcript is transported from the nucleus to the cytoplasm by Exportin 5 (“XPO5”), which can only bind pre-miRNA in the presence of the RAN-GTPase cofactor. TRBP recruits the RNAse III DICER complex and DICER cleaves the transcript into a ds-miRNA guide and passenger strand. The guide strand complexes with Ago2 and other proteins required for miRNA silencing (e.g., GW182) to form RISC. RISC and mRNA targets that associate with sufficient complementarity and energetically favorable structures downregulate mRNA translational expression with mRNA undergoing endonucleolytic cleavage in some cases (e.g., a sufficient number of consecutive Watson-Crick pairs) and translational repression in other cases.

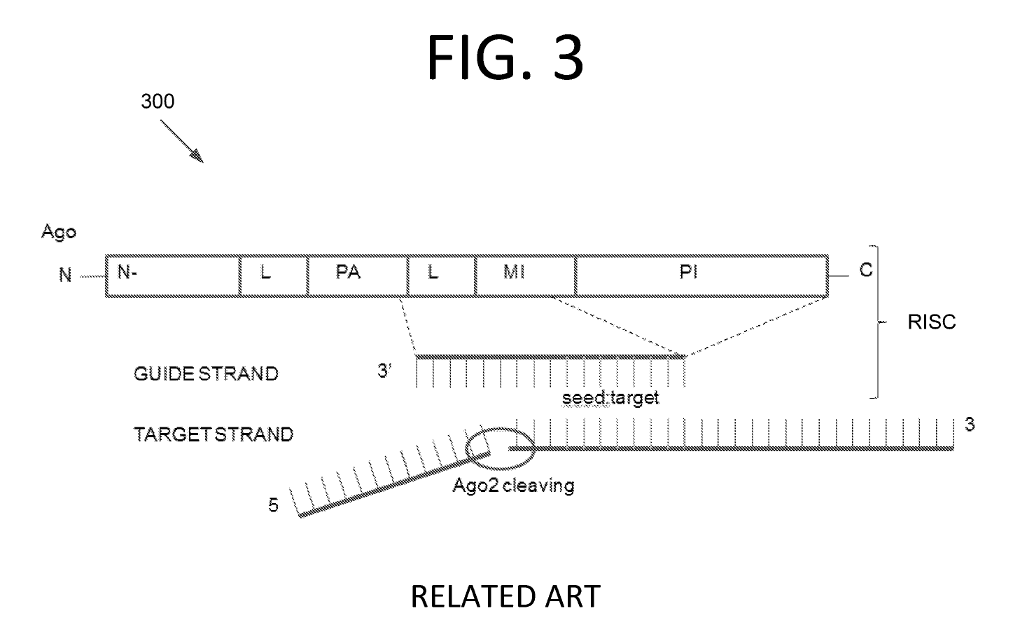

Using data from crystal structures of prokaryotic Thermus thermophilus, details of RNAi silencing through Ago2 binding with a guide strand and a target strand 300 are shown in FIG. 3. The guide strand 3′ end bonds to the PAZ domains and the guide strand 5′ end bonds to the MID and PIWI domains at the C-terminal end. Other nucleic acid-to-protein interaction is via the phosphodiester backbone of the nucleic acid. This permits the protein to accommodate any guide strand of either DNA or RNA.

Some embodiments of the present invention provide a specific protocol for use in screening the human genome for miRNA:mRNA targets, for example. A specific example of the functionality of some embodiments of the model is described in detail herein for a system of let-7d downregulation of six HMGA2 sequences. Such modeling provides a more effective analysis tool.

Generally speaking, some embodiments of the present invention operate as follows. First, the observed action of miRNA downregulation of mRNA expression is mimicked via a cryptographic model. Next, the model is provided with parametric outputs that can be related to observables, measurables, and figures of merit, such as log₂ expression and AG conformational changes. Then, miRNA downregulation experiments are performed to fit the parametric outputs to the observable data. The model is then updated and the downregulation experiments are repeated as needed.

miRNA:mRNA binding represents a problem analogous to the cryptographic problem of the security of short hash codes. A hash code is a cryptographic checksum intended to provide a unique code appended to a message that signifies authenticity of the message and the sender. The shorter the code, the higher the probability that more than one message can generate the same code. miRNA and mRNA binding exhibit a wide range of regulation analogous to the short message/non-unique hash code problem.

A set of mRNAs and a candidate miRNA sequence may be coded from a set of orthogonal binary vectors, operated upon by a set of hash codes representing secondary structure interaction and processed through a security algorithm such as RSA. The decrypted mRNA vectors may then be projected on a set of decrypted miRNA vectors, producing a series of error vectors. The properties of these error vectors may be evaluated against calibration standards of miRNA projected onto a fully complimentary sequence and a fully anti-complimentary sequence. Such embodiments may be particularly useful in designing miRNA sequences with high specificity for use in RNA interference (“RNAi”) therapies.

Coding of Secondary Structure Dictionary

A Huffman code dictionary is generated for a set of secondary structure codes. mRNA folding is necessary for proper functioning of biological activities. The model generally applies a secondary structure code to every sequence (mRNA or miRNA), even if the secondary structure under evaluation is linear. The secondary structure coding allows two identical sequences to be differentiated. Therefore, the secondary sequence coding provides for an authentication capability. In this embodiment, 5 structural categories (classes of symbols) are used, each with a user-defined probability mass function. Table 2 lists the categories. Additional categories of secondary structures can be used or a subset of these categories can be used in some embodiments.

TABLE 2
SECONDARY STRUCTURE CATEGORIES

| Alpha | Description |
|---|---|
| X | Double strand, |
| | unpaired bulge |
| P | Double strand. |
| | W/C pair |
| W | Wobble pair |
| L | Loop |
| S | Ss, unpaired |

The location of each base within the sequence has a probability of being in a given structural category at its location in the nucleotide sequence. The base at that location is assigned a value from the Huffman code dictionary. The dictionary is applied via a language that provides shorthand for performing the secondary structure coding. There are 409 codes assigned to each category, with 3 codes left unused, in embodiments.

The average length of a Huffman code depends on the statistical frequency with which the source produces each symbol from its alphabet. A Huffman code dictionary, which associates each data symbol with a codeword, has the property that no codeword in the dictionary is a prefix of any other codeword in the dictionary. The statistical frequency of a given secondary structure can be correlated to its Huffman code. Let N equal a finite field of a secondary structure space partitioned into sets of five members, with q=409:

Nₖ={Xᵢ,Pᵢ,Wᵢ,Lᵢ,Sᵢ},1≦i≦q,1≦k≦22

X={SS₁^{x},SS₂^{x}, . . . ,SS_{q}^{x}}

P={SS₁^{p},SS₂^{p}, . . . ,SS_{q}^{p}}

W={SS₁^{w},SS₂^{w}, . . . ,SS_{q}^{w}}

L={SS₁^{l},SS₂^{l}, . . . ,SS_{q}^{l}}

S={SS₁^{s},SS₂^{s}, . . . ,SS_{q}^{s}}

Each base in the RNA sequence has a secondary structure defined with N such that the k^{th} member of the sequence equals:

$${N}_{k} = \{ \begin{matrix}\begin{matrix}{X}_{i} \\ 0\end{matrix} , & if base is double strand , unpaired bulge , else \\ \begin{matrix}{P}_{i} \\ 0\end{matrix} , & if base is double strand , W - C paired , else \\ \begin{matrix}{W}_{i} \\ 0\end{matrix} , & if base is G - U wobble paired , else \\ \begin{matrix}{L}_{i} \\ 0\end{matrix} , & if base is unpaired in a loop , else \\ \begin{matrix}{S}_{i} \\ 0\end{matrix} , & if base is in single strand , unpaired\end{matrix}$$

For every base in the sequence, one of the above conditions is satisfied. The Hamming distance between nearest neighbors in any given set is:

d(SSᵢ^{x},SSᵢ₊₁^{x})=3

d(SSᵢ^{p},SSᵢ₊₁^{p})=3

d(SSᵢ^{w},SSᵢ₊₁^{w})=3

d(SSᵢ^{l},Sᵢ₊₁^{l})=6

d(Sᵢ^{s},SSᵢ₊₁^{s})=3

Each of the 409 sets of five base configurations can be assigned either absolute or relative energy metrics. A greater Hamming distance has been placed between adjoining loop members in this embodiment. Hamming distances between neighbors can be correlated a posterori to steric and electrostatic energy differences between secondary structures. For the purposes of modeling, the exact quantitative values may not be known, but the relative, differences can be used as a metric (i.e., large Hamming distances equate to large energy differences). Each 15 bit secondary structure code may be treated as a 7-bit code consisting of the seven most significant bits (“MSBs”) and an 8-bit code consisting of the eight least significant bits (“LSBs”). The purpose of this split is to compensate for any biases that might result if a string of adjacent 15-bit words had a greater weight in the MSBs or LSBs. This also reduces any bias introduced in the detuning process.

The hash code sequences are 15 bits long in this embodiment, and the miRNA and mRNA sequences are each split into two sequences. Prior to the split, each RNA sequence (either miRNA or RNA) is represented by 22×15 matrix of binary values. The 22 rows represent one row for each base in the RNA sequence. The 15 columns represent the coding of the base in its secondary structure space. After the completion of this step, each RNA sequence is represented by a 1×22 vector of integers generated from 7 MSBs and a 1×22 vector of integers generated by the 8 MSBs. The model can be calibrated to utilize different channel coding lengths and schemes, so long as the length of code is an odd number of bits split into two subsequences.

This type of transformation is used to reduce any code bias. The resulting 15-bit secondary structure code is XOR'd with the 15-bit sequence code for each of the 22 bases in the sequence.

Source coding of mRNA and miRNA sequences

miRNA and mRNA sequences are coded into a 15-bit Hamming code space in some embodiments. Hamming codes are a family of linear error-correcting codes that can detect and correct one hit errors in a code sequence. A binary Hamming code Hᵣ, of length n=2^{r}−1 (with r≧2) is a linear code with parity-check matrix H whose columns consist of all nonzero binary vectors of length r, each used once.

A binary representation of the four RNA bases may be generated from a series of four orthogonal 11-bit vectors. Each base may be represented by a (15,11) Hamming code, although different numbers of bits may be used in other embodiments. A (15, 11) Hamming code codes an 11-bit data field in 15 bits and provides 4 parity check bits. The Hamming codeword representation of members of a sequence (nucleotides, amino acids, etc.) is useful because correctable and uncorrectable errors in a sequence can be utilized as a damage metric (for example, elastic vs. plastic deformations for other models). The four bases in this embodiment are coded as shown in Table 3 below. It is noted that other encodings are possible in other embodiments.

TABLE 3
RNA BASE BINARY CODING

| | | | | | | | | | | | | | | | |
|---|---|---|---|---|---|---|---|---|---|---|---|---|---|---|---|
| adenine | 0 | 0 | 0 | 0 | 0 | 0 | 0 | 0 | 0 | 1 | 1 | 0 | 0 | 1 | 0 |
| cytosine | 1 | 1 | 1 | 0 | 1 | 0 | 0 | 1 | 0 | 0 | 0 | 0 | 1 | 0 | 0 |
| guanine | 0 | 0 | 1 | 1 | 0 | 0 | 0 | 0 | 1 | 0 | 0 | 0 | 0 | 0 | 1 |
| uracil | 0 | 0 | 1 | 0 | 0 | 1 | 1 | 0 | 0 | 0 | 0 | 1 | 0 | 0 | 0 |

The RNA sequence is a concatenation of the binary codes of each base.

Encryption with the RSA Algorithm

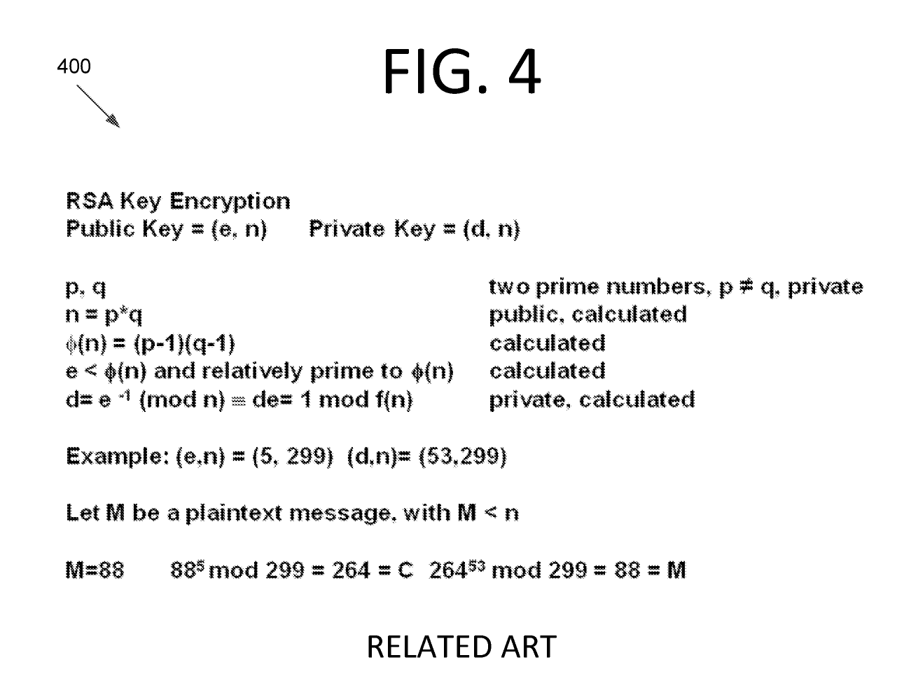

The RSA asymmetric encryption algorithm was developed by Rivest, Shamir, and Adelman (hence, the name “RSA”) from MIT to facilitate development of public key infrastructure-based security. Originally a classified algorithm, RSA passed into the public domain in September of 2000. The RSA algorithm is a convenient mechanism for generating public/private key pairs for evaluation of secondary structure hash codes, although other suitable algorithms may be used in some embodiments. FIG. 4 illustrates the RSA methodology 400. In this model, 3 sets of RSA public/private key pairs are utilized to eliminate any possible bias that might be introduced by a single set of keys. Table 4 lists the keys used by the prototype model.

TABLE 4
RSA ENCRYPTION/DECRYPTION KEYS

| e | d | n |
|---|---|---|
| 5 | 53 | 299 |
| 1657 | 73 | 24811 |
| 89 | 233 | 5629 |

RSA Decryption and Detuning

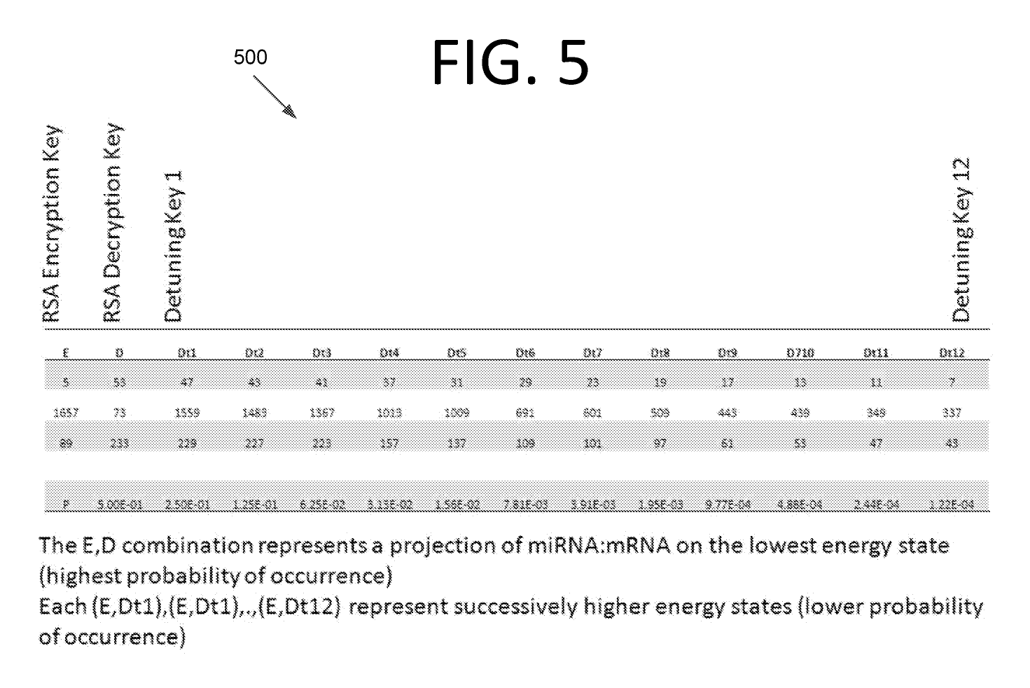

The operation of decryption with keys of successively greater distances from the primary decryption key represents thermodynamic states of lower stability and lower probability of occurrence for a given sequence. FIG. 5 illustrates the keys 500 used in developing the model.

For example, encryption over the set (e,n)={5,299} is decrypted (d,n) over the space: {(53,299), (47,299), (43,299), (41,299), . . . , (11,299), (7,299)}. Encryption over the set (e,n)={1657,24811} is decrypted (d,n) over the space: {(73,24811), (1559,24811), (1483,24811), . . . , (349,24811), (337,24811)}. Encryption over the space (e,n)={89,5629} is decrypted (d,n) over the space {(233,5629), (229,5629), (227,5629), (223,5629), . . . , (47,5629), (43,5629)}. The bottom row of FIG. 5 lists the probability P associated with the respective (d,n).

Modeling Process

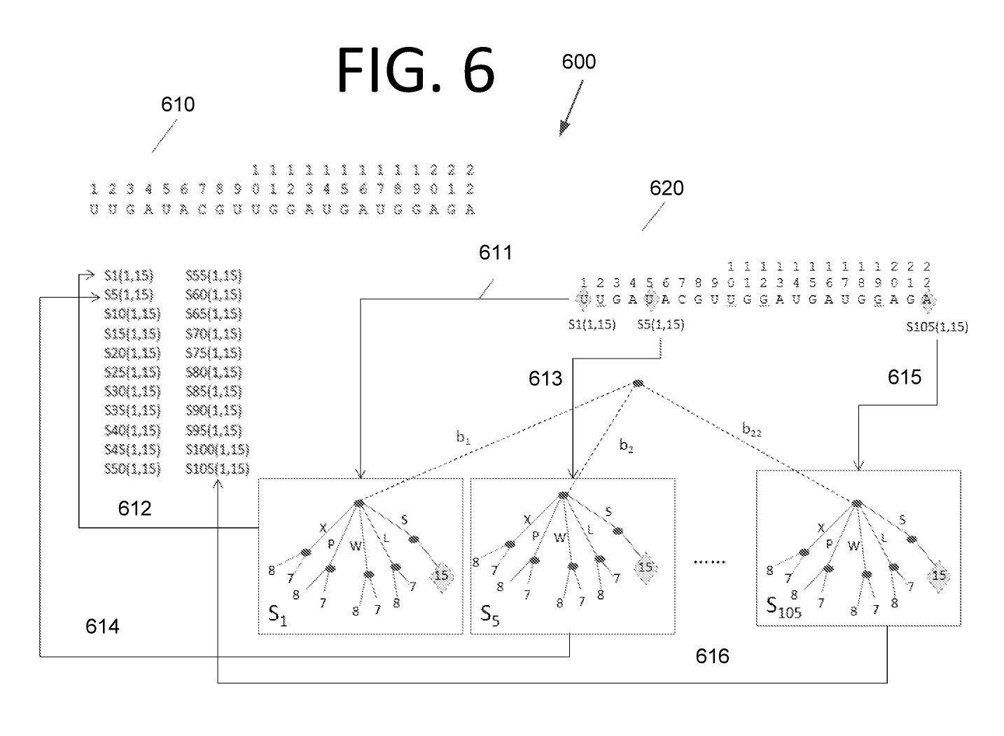

The modeling process begins with FIG. 6 to code the RNA sequences with primary structure and secondary structure sequence codes as previously described. FIG. 6 illustrates the construction 600 of a secondary structure source code from a secondary structure codebook (database) for an RNA sequence that is single-stranded, according to an embodiment of the present invention. The primary structure is the sequence of bases. The secondary structure is the folding of the bases to form a more complex structure. In the case of a sequence of 22 RNA bases, each base has a primary structure code and a secondary structure code.

The secondary structure may be programmed using the language syntax shown in FIG. 6. A single string of an RNA sequence (either miRNA or mRNA) is depicted, in which the secondary structure is not folded. At 610, the miRNA sequence for let-7d is depicted with its sequence location from base 1 on the left to base 22 on the right. At 620, the miRNA sequence is shown with an example highlighting of the secondary structure code for three bases in the sequence: S1, S5, and S22. At 611, the traversal of a code tree is depicted for S1(1,15) to retrieve the 15-bit code from the dictionary set S1 and the code is assigned to the first base as shown in syntax 612. At 613, the traversal of a code tree is depicted for S5 (1,15) to retrieve the 15-bit code from the dictionary set S5. The 15-bit code is assigned to the second base in the sequence, as shown in syntax 612, and so forth at 614, until the 22nd base at 615, which depicts the traversal of a code tree for S105(1,15) to retrieve the 15-bit code from the dictionary set S105 and assigns the code to the 22^{nd} base, as shown in syntax 616.

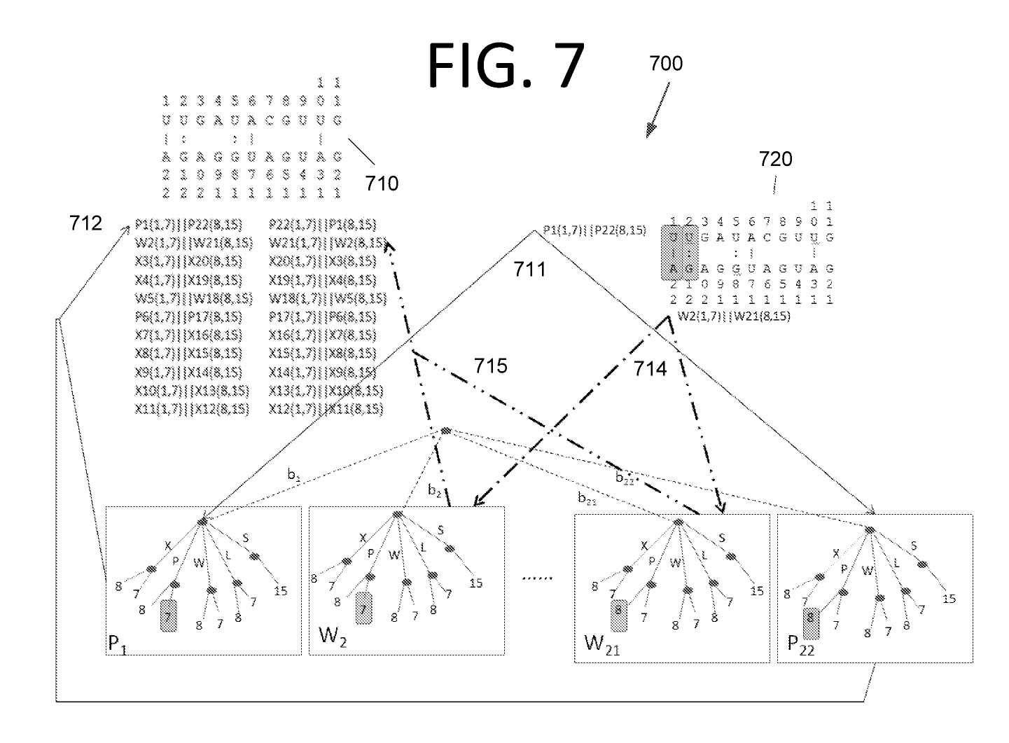

FIG. 7 illustrates the construction 700 of a secondary structure source code from the secondary structure codebook (database) for an RNA sequence that is folded and contains Watson-Crick and guanine-adenine wobble pairs, according to an embodiment of the present invention. In FIG. 7, the let-7d structure at 710 is folded such that base number 1 and base number 22 form a Watson-Crick pair and base number 2 and base number 21 form a guanine-uracil (G:U) wobble pair. At 720, the folded sequence is shown with the example highlighted of base 1 paired with base 22 and base 2 paired with base 21.

The 7 MSBs from dictionary set P1 of the first Watson-Crick pair code are concatenated with the 8 LSBs of dictionary set P22 at 711 for the twenty-second Watson-Crick pair code. In the 12th line of the program, the 7 MSBs from dictionary set P22 of the first Watson-Crick pair codes are concatenated with the 8 LSBs of dictionary set P1 as shown in syntax 712. Next, the 7 MSBs from dictionary set W2 of the G:U wobble pair code are concatenated with the 8 LSBs of dictionary set W21 at 514 for the twenty-first G:U wobble pair code. In the 13^{th} line of the program, the 7 MSBs from dictionary set W21 of the first Watson-Crick pair codes are concatenated with the 8 LSBs of dictionary set W2 as shown in syntax of 715.

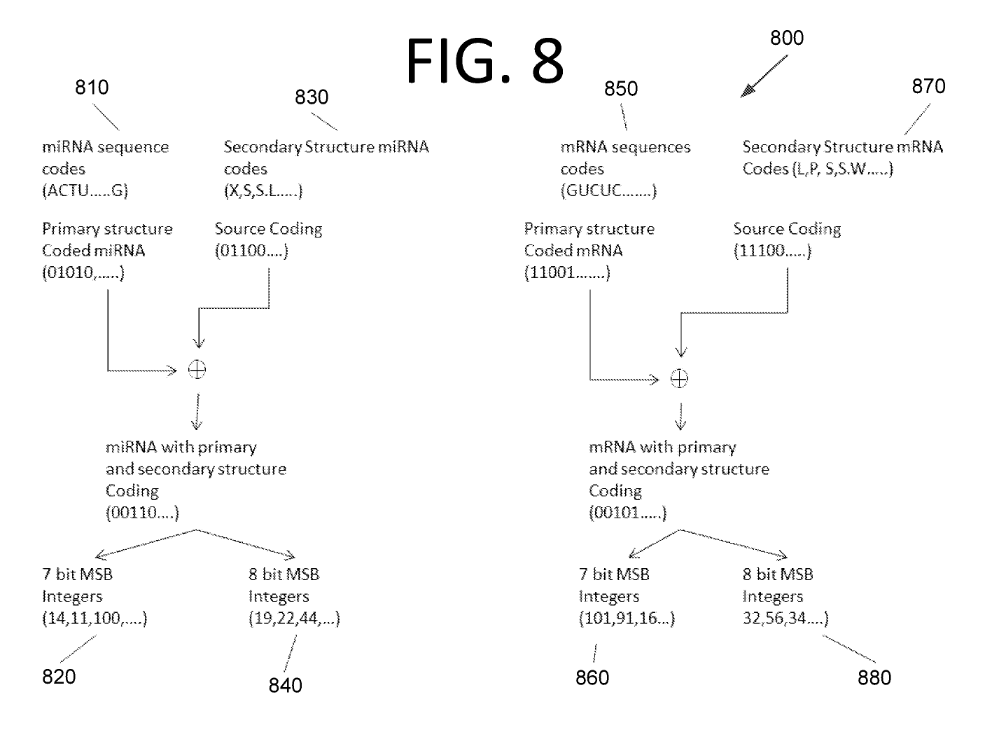

FIG. 8 illustrates the coding phase 800 (step 1) of the modeling process, according to an embodiment of the present invention. Each binary representation is split into its 7 MSBs and 8 LSBs and converted to integers. miRNA sequence codes 810 and secondary structure codes 830 are transformed into a 7-bit miRNA integer sequence 820 and an 8-bit miRNA integer sequence 840. mRNA sequence codes 850 and secondary structure codes 870 are transformed into a 7-bit mRNA integer sequence 860 and an 8-bit mRNA integer sequence 880.

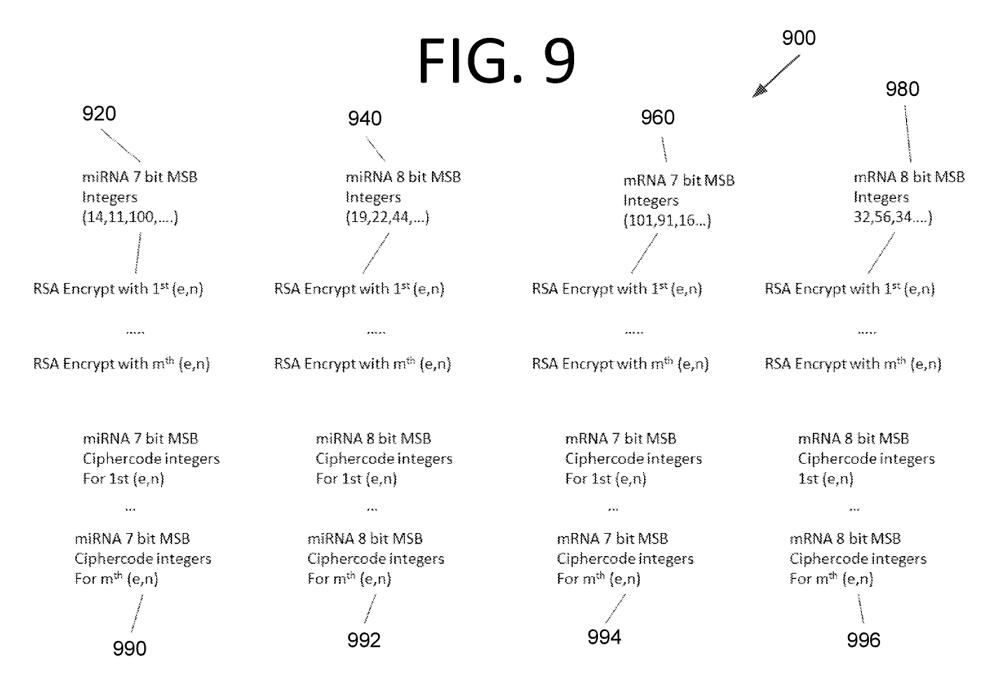

FIG. 9 illustrates the encryption phase 900 (step 2) of the modeling process, according to an embodiment of the present invention. The integer codes from FIG. 8, now designated as 920, 940, 960 and 980 in FIG. 9, representing 7-bit miRNA, 8-bit miRNA, 7-bit mRNA, and 8-bit mRNA, respectively, are encrypted by the RSA algorithm as shown in pairs of (e,n). In this case, m=3 pairs of (e, n): (53,299), (1657,24811), and (89,5629). This yields miRNA 7-bit MSB ciphercode integers 990, miRNA 8-bit MSB ciphercode integers 992, mRNA 7-bit MSB ciphercode integers 994, and mRNA 8-bit MSB ciphercode integers 996.

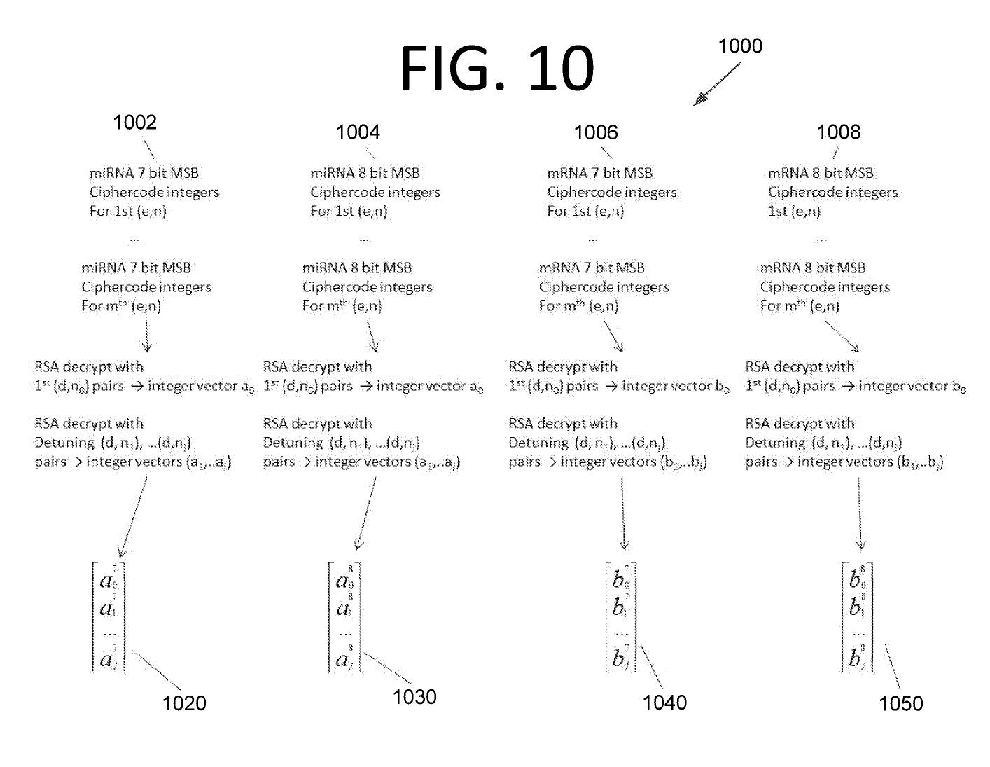

FIG. 10 illustrates the decryption and detuning phase 1000 (step 3) of the modeling process, according to an embodiment of the present invention. The encrypted vectors 1002, 1004, 1006, 1008 are successively decrypted first with the correct key (d, n₀) and then with j successive off-keys in a detuning process (d, n₁, . . . , nⱼ)). In FIG. 10, j=12, for a total of 13 decryption operations yielding the output vectors 1020, 1030, 1040, and 1050 for 7-bit miRNA, 8-bit miRNA, 7-bit mRNA, and 8-bit mRNA decryptions, respectively.

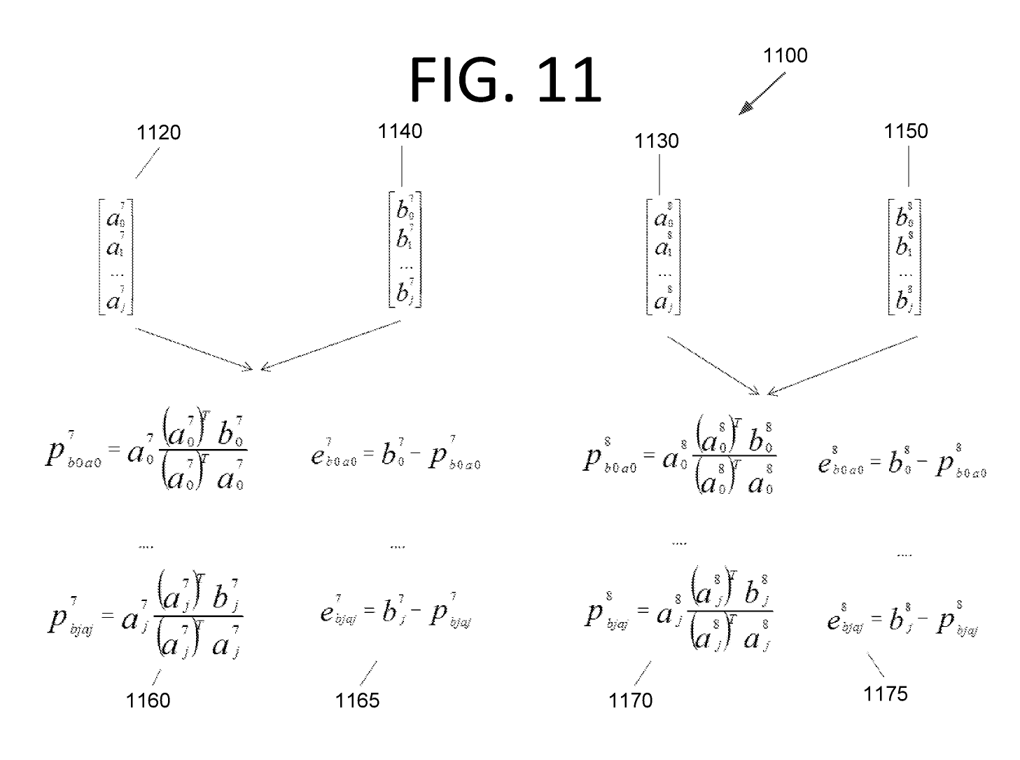

FIG. 11 illustrates the vector projection phase 1100 (step 4) of the modeling process, according to an embodiment of the present invention. The mRNA decrypted vectors are projected onto the miRNA decrypted vectors (or vice versa) as by linear algebra. Vector 1120 is projected onto the column space of vector 1140, resulting in projections 1160 and error vectors 1165. Vector 1130 is projected onto the column space of vector 1150, resulting in projections 1170 and error vectors 1175. The error vector of a sequence projected onto itself results in a zero error vector and this relationship is used as check on the accuracy of the process.

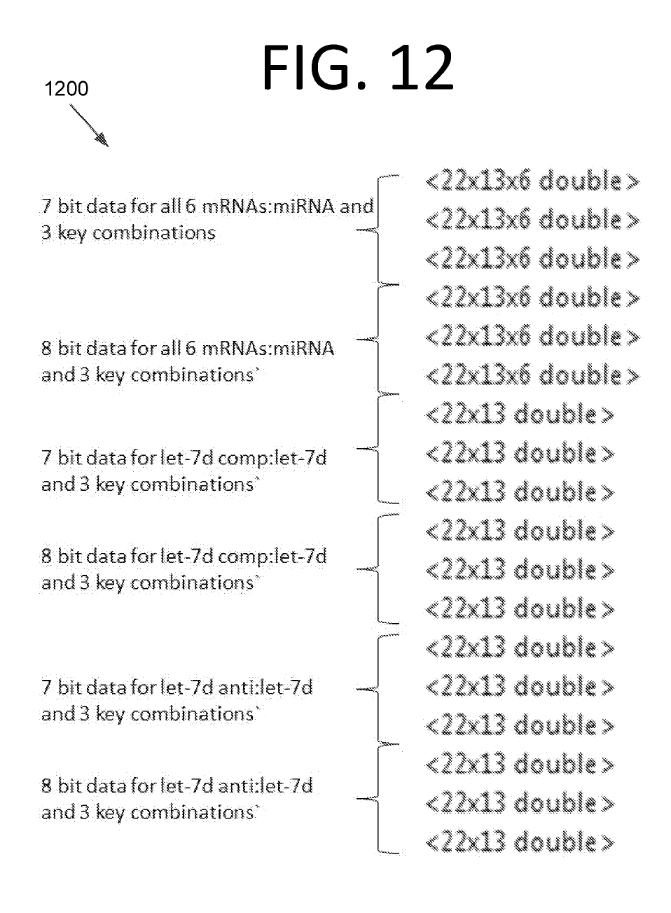

The required projections include: (1) the mRNA sequences onto the miRNA sequence of interest for the 7-bit and 8-bit vectors; (2) the miRNA sequence onto the fully complimentary miRNA sequence; and (3) the miRNA sequence onto the fully anti-complimentary miRNA sequence. FIG. 12 illustrates a sample summary 1200 of the raw data output of error vectors produced after phase 1100 of FIG. 11.

Each vector represents a space projection of a given mRNA-on-miRNA sequence. Each value represents a state of a base pair. Each successive detuning of the decryption keys alters the space projection of the vector and the state of each base pair. Each state is associated with a probability that the base pair will be in that state. The greater the detuning, the lower the probability. The cumulative distribution function (“CDF”) of all states is equal to 1.

After phase 1100 of FIG. 11, the data is analyzed to produce miRNA:mRNA seed:target analysis results. A variety of levels of analysis are possible and the user can employ data reduction techniques of his or her choosing.

In general, two similar miRNA:mRNA pairs with similar rates of downregulation should have similar error projection characteristics when compared base pair-by-base pair. When analyzing data for comparison against published reference data, the decryption keys and the 7-bit or 8-bit decryption vectors can be used to discriminate data that approaches published information. Dissimilar pairs should have consistent, identifiable differences in the error projections and scoring. The detuning process is meant to model a wide range of molecular interactions. The scoring process is a filter to reduce the dataset to the most significant information.

Scoring to predict downregulation of a miRNA:mRNA Combination

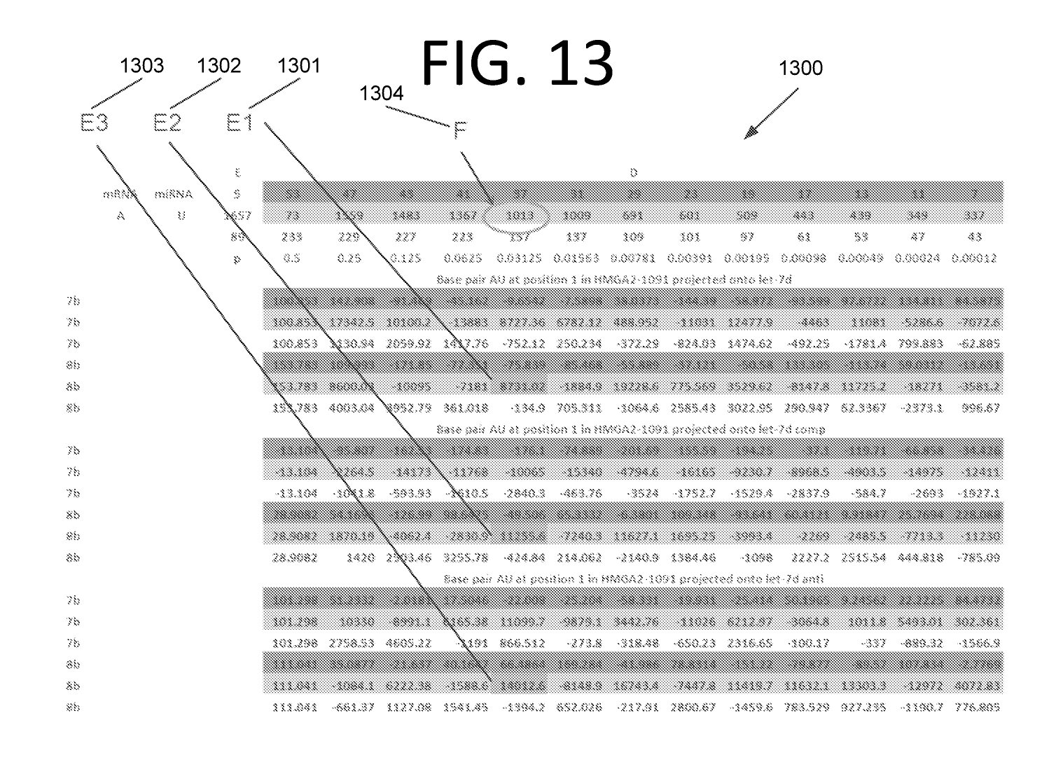

FIG. 13 illustrates error projections 1300 that will be used to demonstrate downregulation scoring for some embodiments. The error vector representing mRNA HMGA2-1091 is projected on miRNA let-7d. Analysis is on FIG. 13 for the 8-bit LSB projection on the first base in the sequence, adenine, paired with uracil in position 1, and shown in Table 6 below.

TABLE 6
mRNA HMGA2-1091 AND miRNA let-7d

| | |
|---|---|
| HMGA2-1091 | AGACCUGAAUACCACUUACCUC |
| let-7d | UUGAUACGUUGGAUGAUGGAGA |

The following equations apply:

$${c}_{1} = \sqrt{{E}_{1}^{2} + {F}^{2}}$$

$${c}_{2} = \sqrt{{E}_{2}^{2} + {F}^{2}}$$

$${c}_{3} = \sqrt{{E}_{3}^{2} + {F}^{2}}$$

$$sin {θ}_{1} = \frac{{E}_{1}}{{c}_{1}} , \\ {θ}_{1} = {sin}^{- 1} {θ}_{1}$$

$$sin {θ}_{2} = \frac{{E}_{2}}{{c}_{2}} , \\ {θ}_{2} = {sin}^{- 1} {θ}_{2}$$

$$sin ρ = \frac{{E}_{3}}{{c}_{3}} , \\ ρ = {sin}^{- 1} ρ$$

Significance of the Relationship Between θ and ρ

θ represents the angular distance between the mRNA:miRNA projection to a perfectly complimentary sequence projected on the miRNA (let-7d comp:let-7d). The smaller the angular distance, the greater the similarity between the state of the base pair in mRNA:miRNA and the corresponding mRNA comp:miRNA. φ represents the angular distance between the mRNA:miRNA projection to a perfectly anti-complimentary sequence projected on the miRNA (let-7d anti:let-7d). The smaller the angular distance, the greater the similarity between the state of the base pair in mRNA:miRNA and the corresponding mRNA anti:miRNA. It is postulated that there is exists a θ and φ that represents a maximization of the probability of stabilizing the sequences such that downregulation is maximized. There are 24 possible combinations ordering the magnitude and signs of three hypotenuses c₁, c₂, and c₃, where c₁ is the hypotenuse of the right triangle formed by the base along the x-axis from zero to the decryption key and the height from 0 to E₁, c₂ is the hypotenuse of the right triangle formed by the base along the x-axis from zero to the decryption key and the height from 0 to E₂, and c₃ is the hypotenuse of the right triangle formed by the base along the x-axis from zero to the decryption key and the height from 0 to E₃. These combinations are shown in Table 7.

TABLE 7
VECTOR COMBINATIONS

```
  1. c1 > c2 > c3, all positive
  2. c1 > c2 > c3, c3 < 0
  3. c1 > c2 > c3, c2 < 0, c3 < 0
  4. c1 > c2 > c3, c1 < 0, c2 < 0 c3 < 0
  5. c1 > c3 > c2, all positive
  6. c1 > c3 > c2, c2 < 0
  7. c1 > c3 > c2, c3 < 0, c2 < 0
  8. c1 > c3 > c2, c1 < 0, c3 < 0 c2 < 0
  9. c2 > c1 > c3, all positive
10. c2 > c1 > c3, c3 < 0
11. c2 > c1 > c3, c1 < 0, c3 < 0
12. c2 > c1 > c3, c2 < 0, c1 < 0, c3 < 0
13. c2 > c3 > c1, all positive
14. c2 > c3 > c1, c1 < 0
15. c2 > c3 > c1, c3 < 0, c1 < 0
16. c2 > c3 > c1, c2 < 0, c3 < 0, c1 < 0
17. c3 > c1 > c2, all positive
18. c3 > c1 > c2, c2 < 0
19. c3 > c1 > c2, c1 < 0, c2 < 0
20. c3 > c1 > c2, c3 < 0, c1 < 0, c2 < 0
21. c3 > c2 > c1, all positive
22. c3 > c2 > c1, c1 < 0
23. c3 > c2 > c1, c2 < 0, c1 < 0
24. c3 > c2 > c1, c3 < 0, c2 < 0, c1 < 0
```

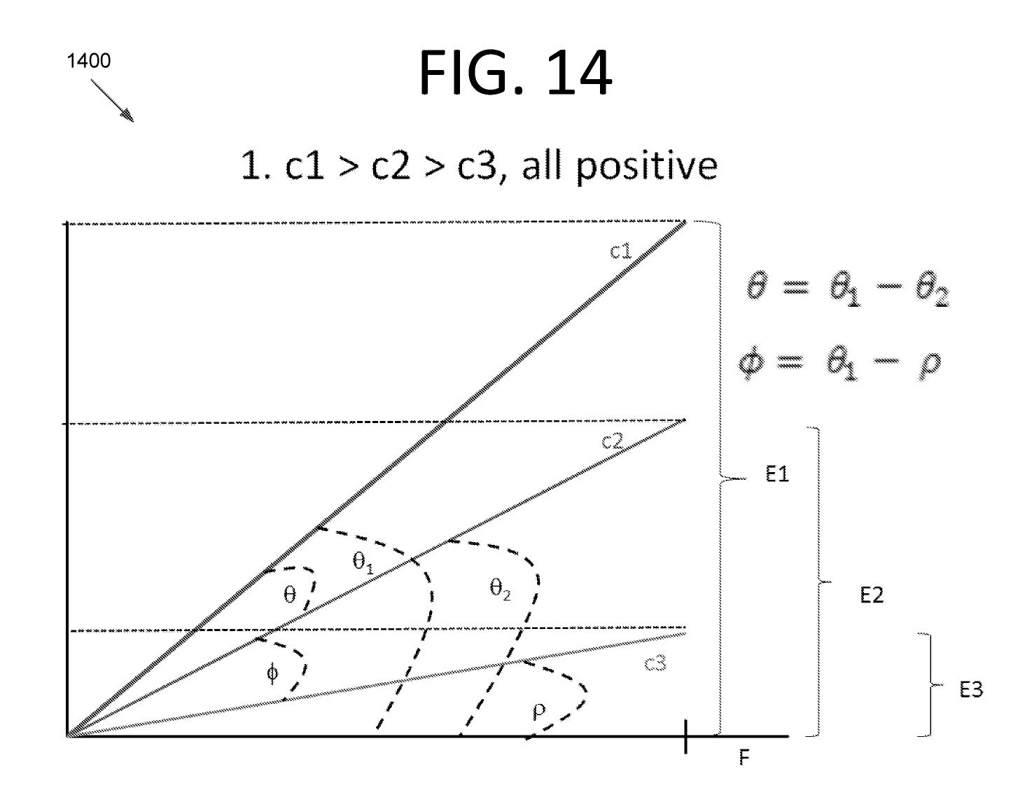

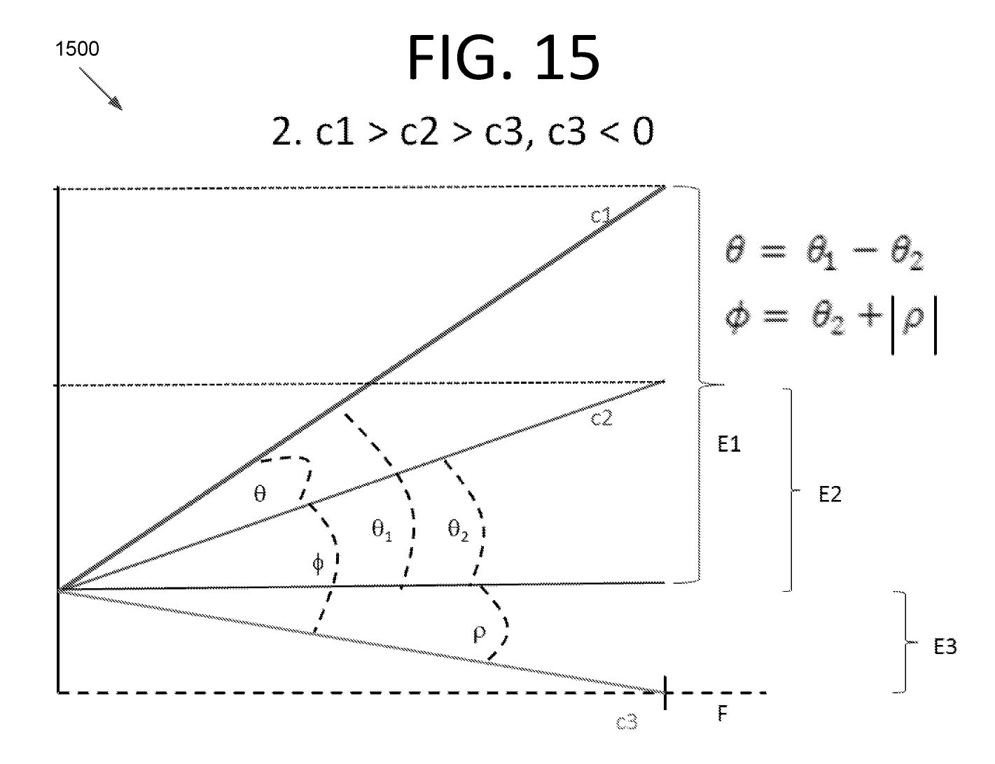

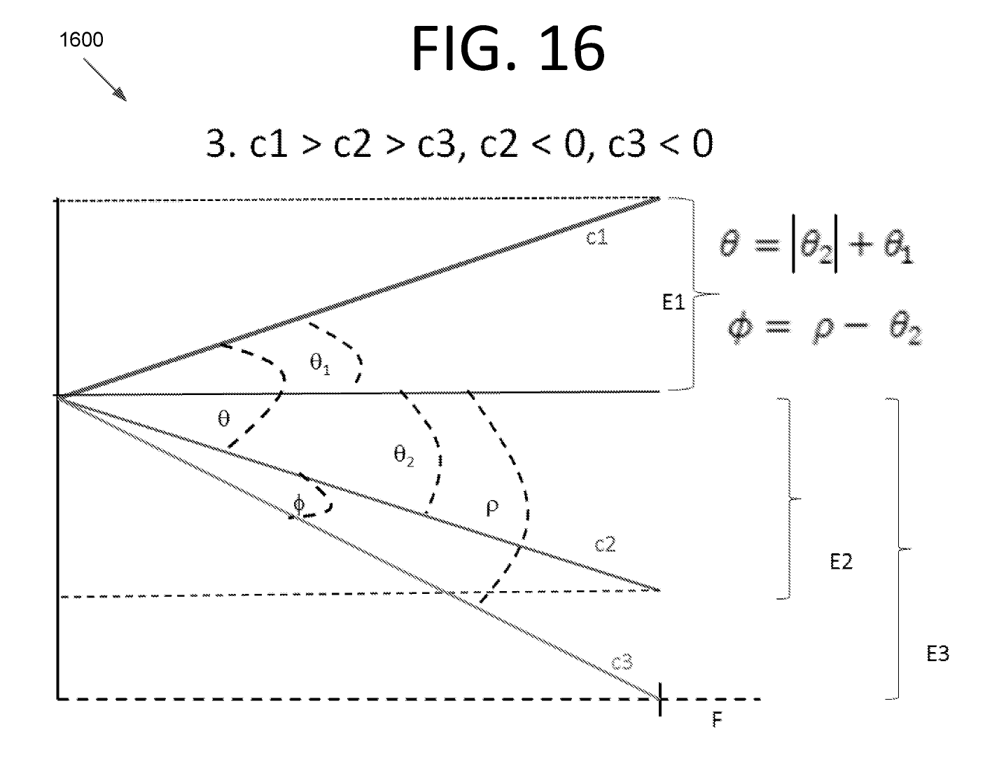

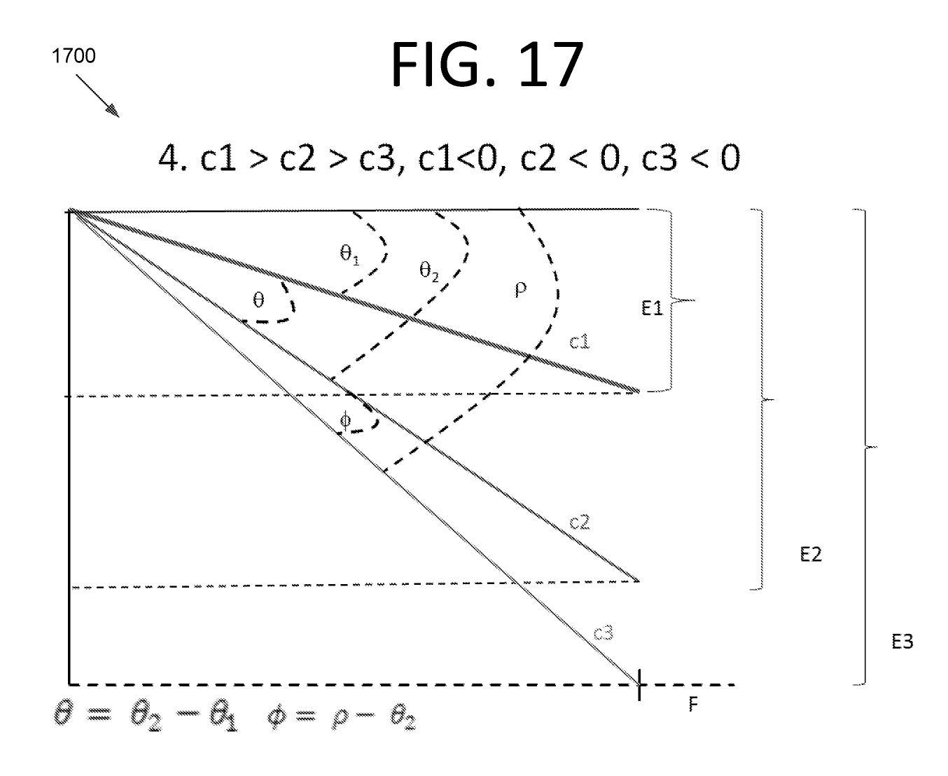

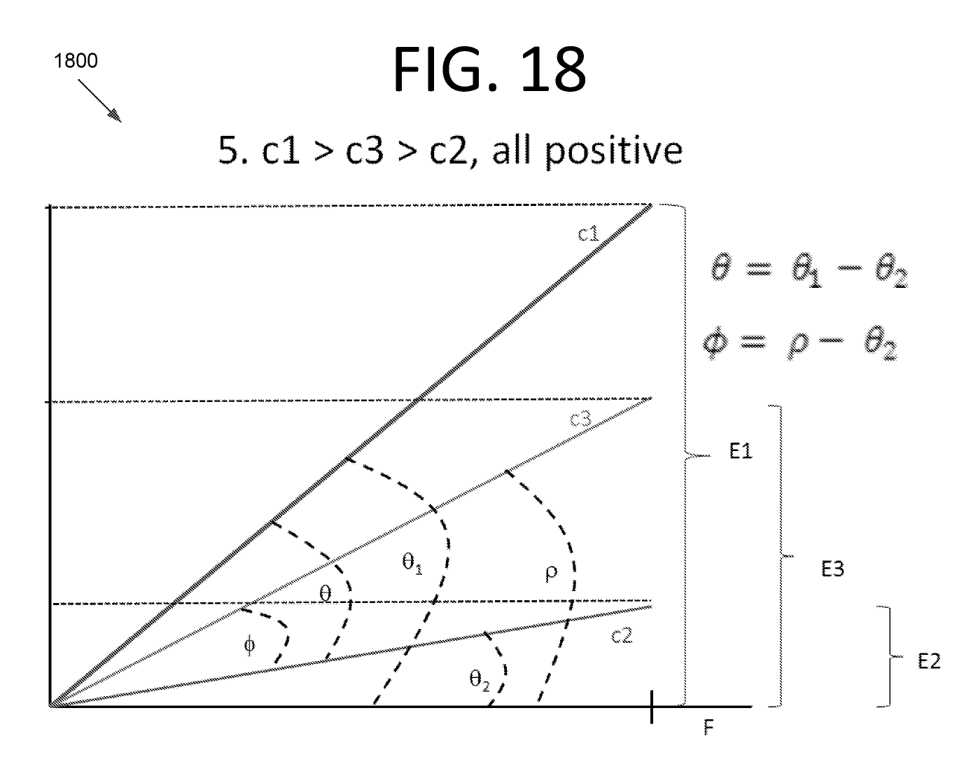

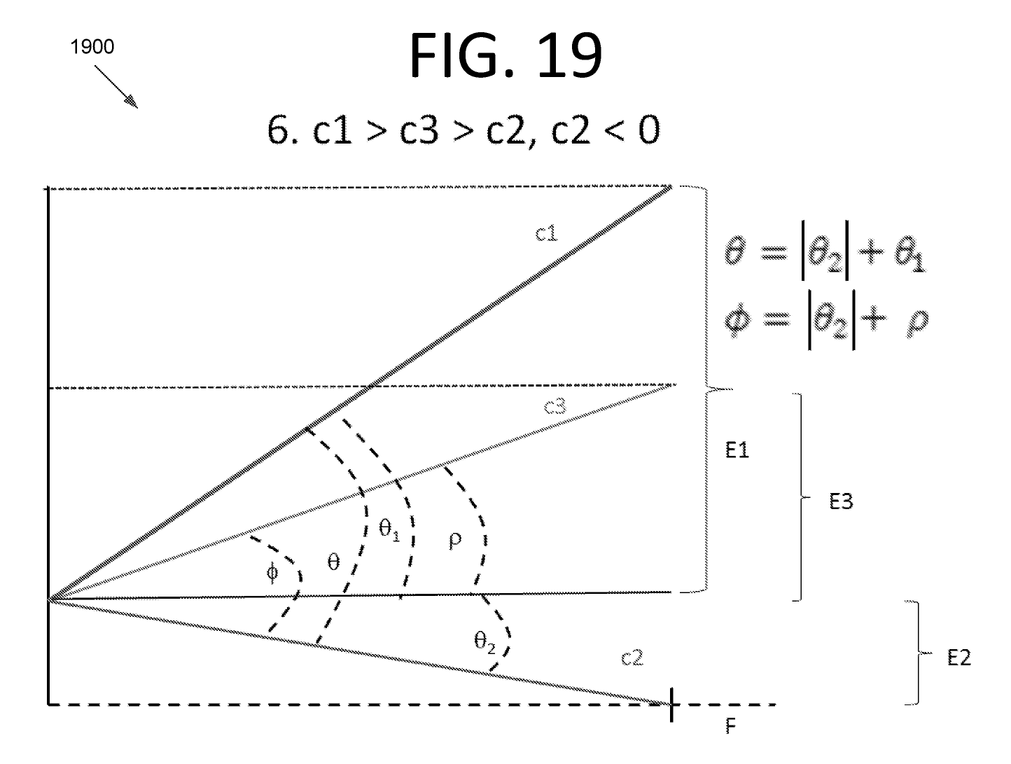

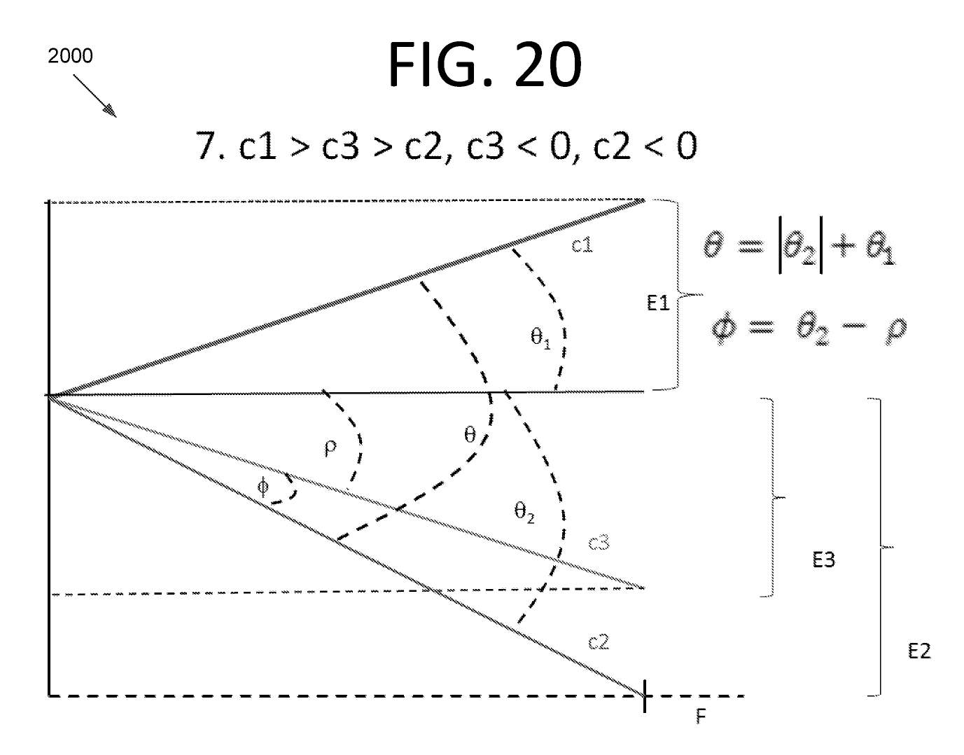

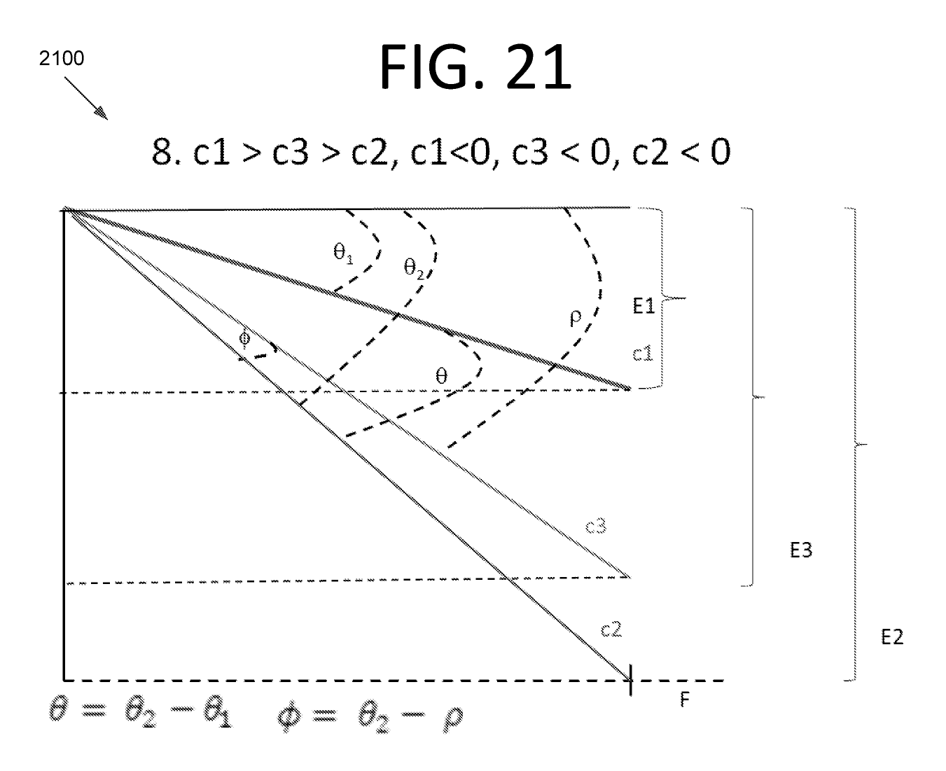

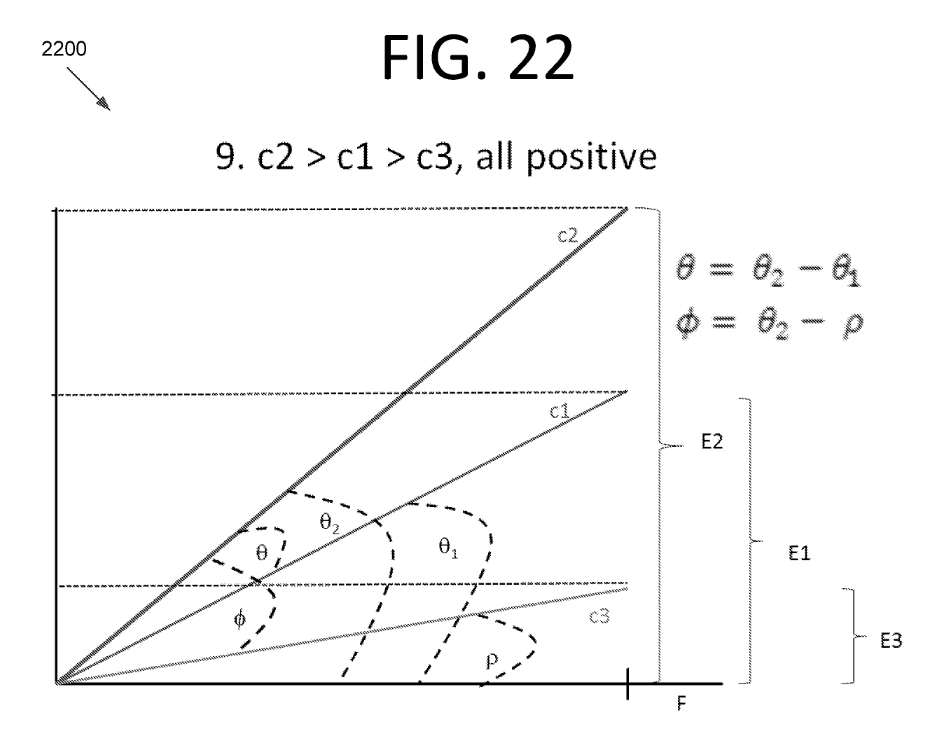

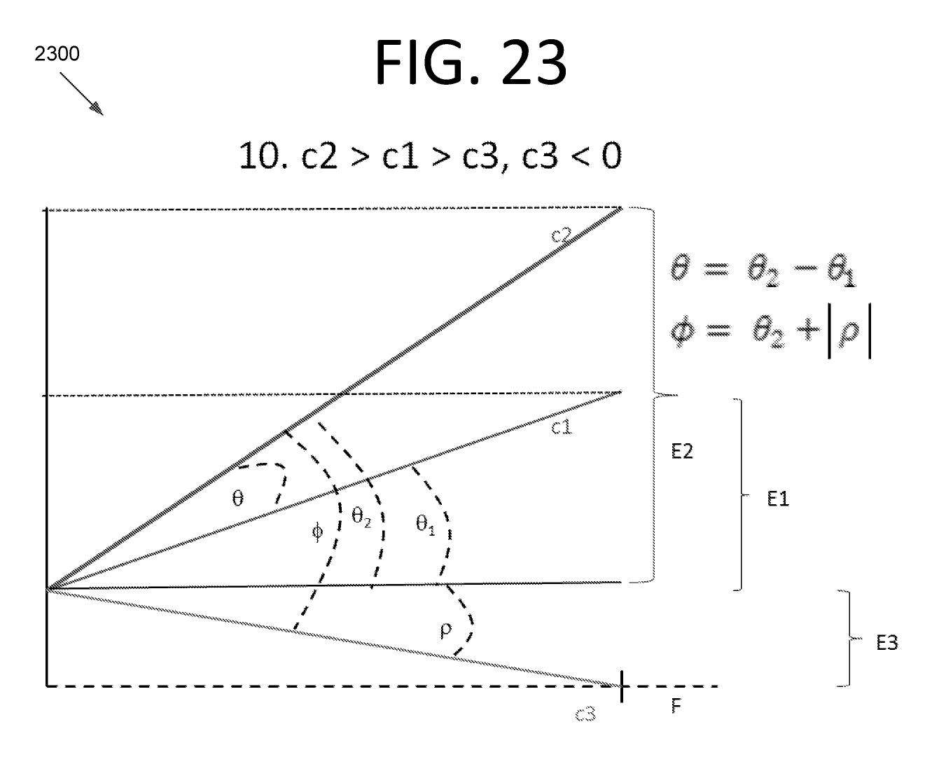

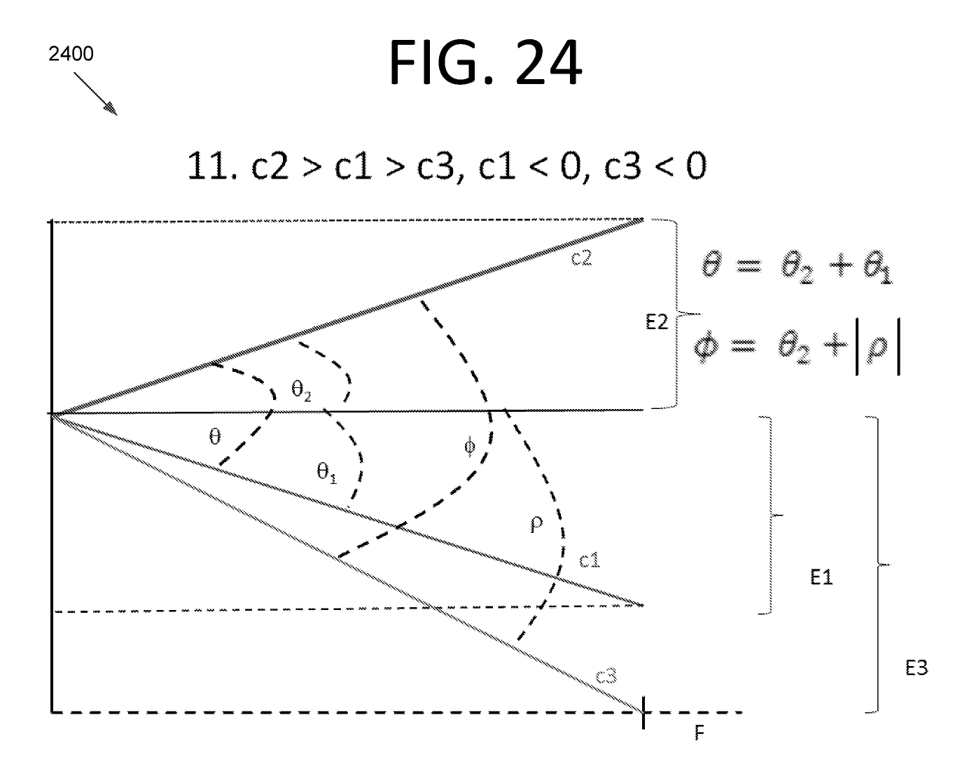

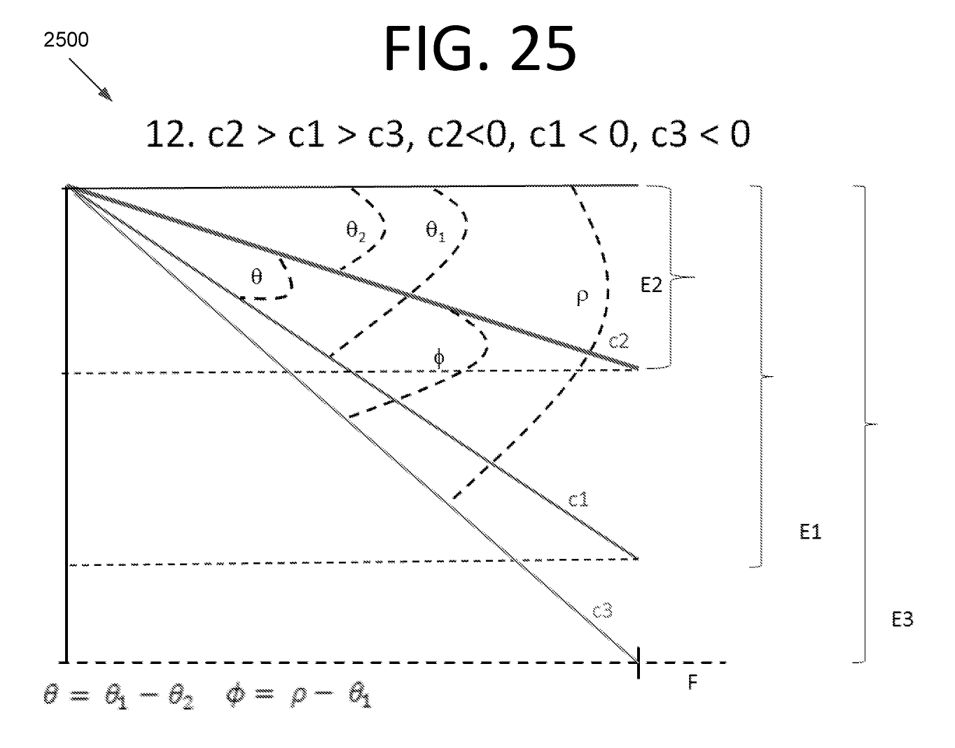

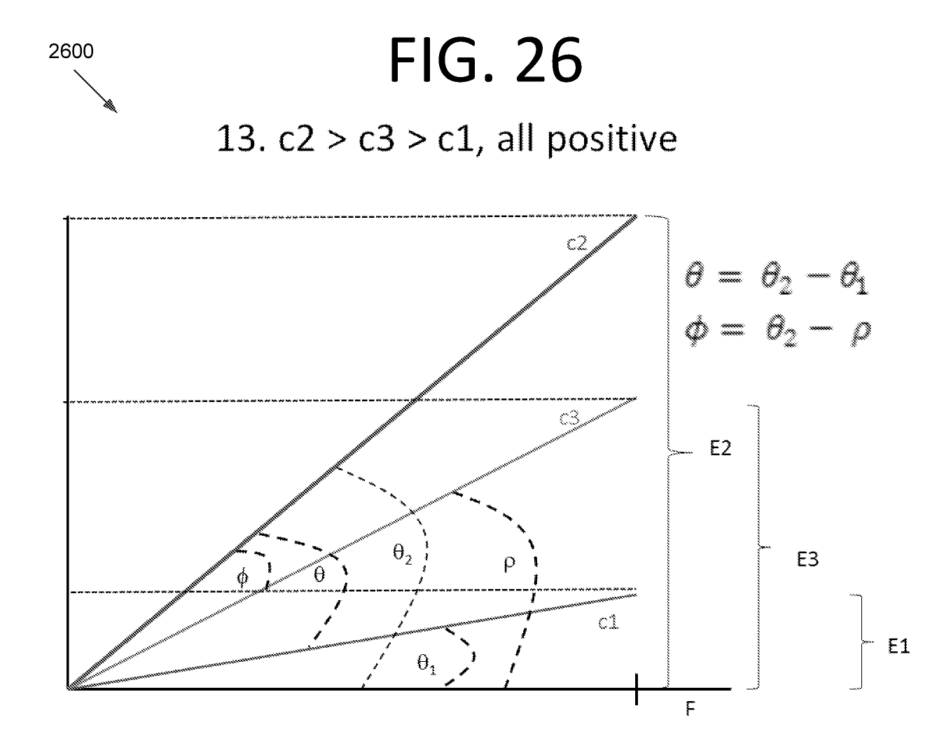

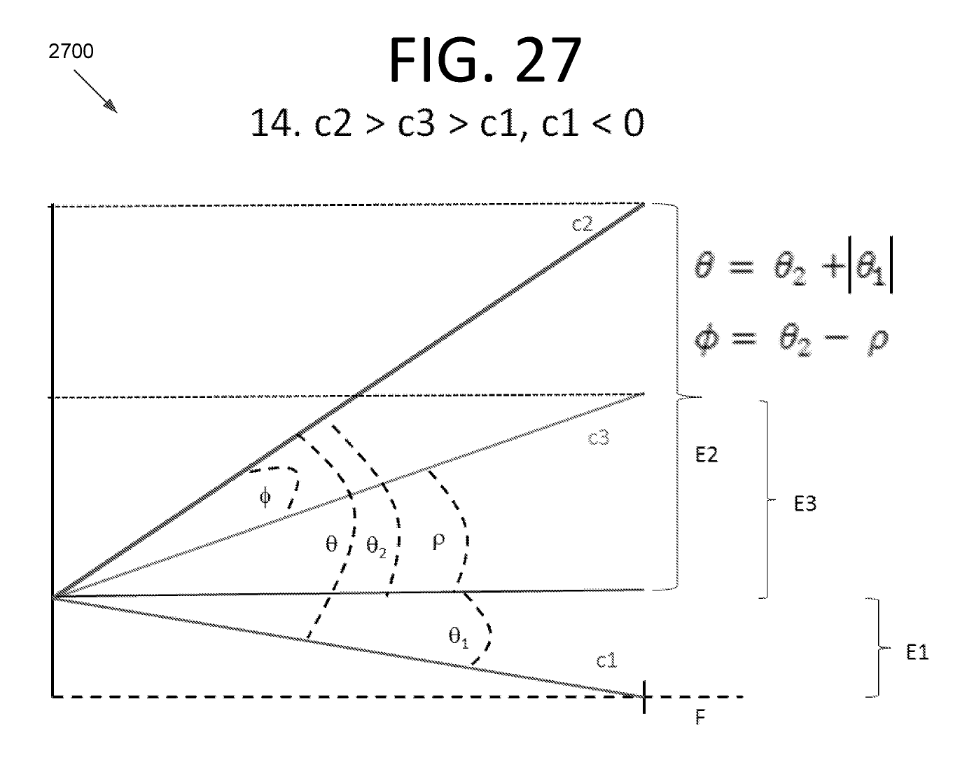

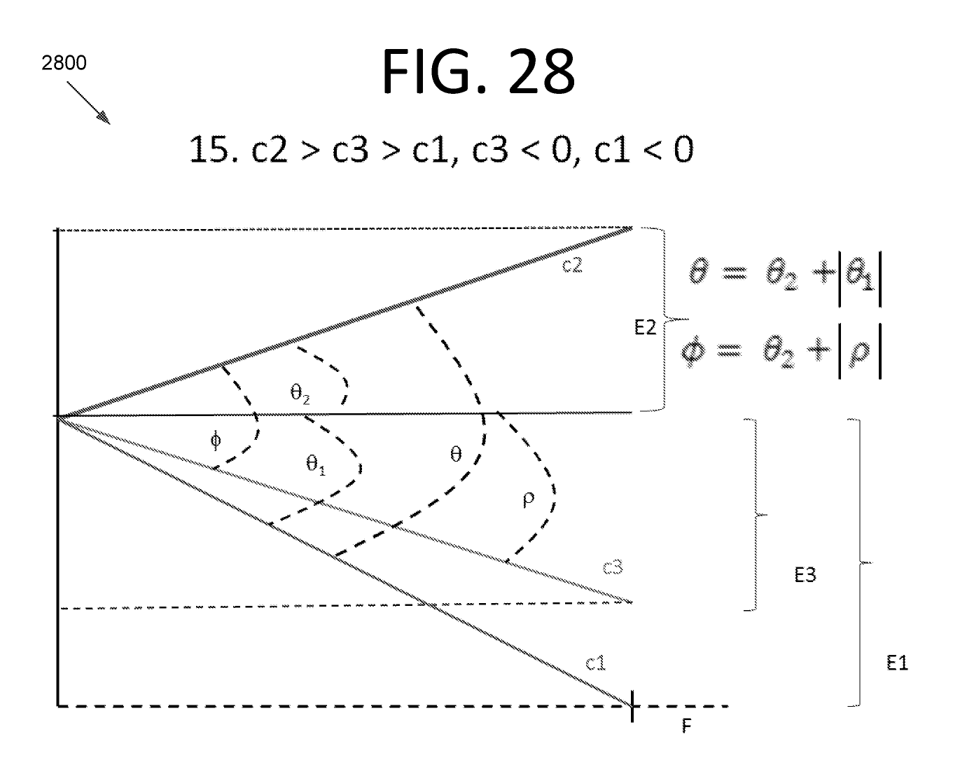

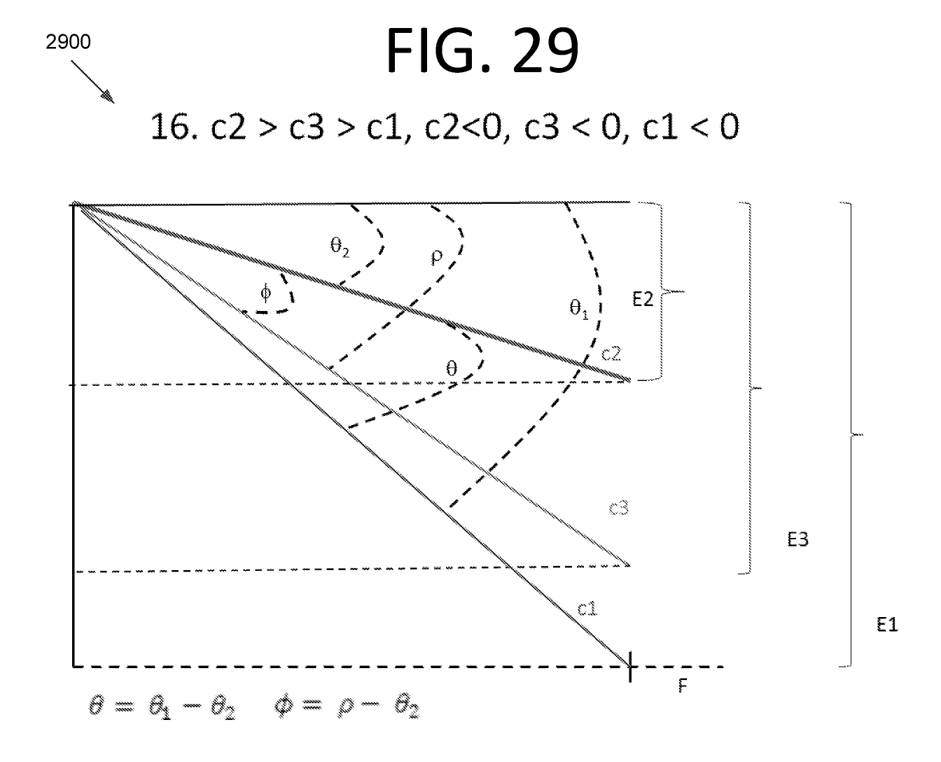

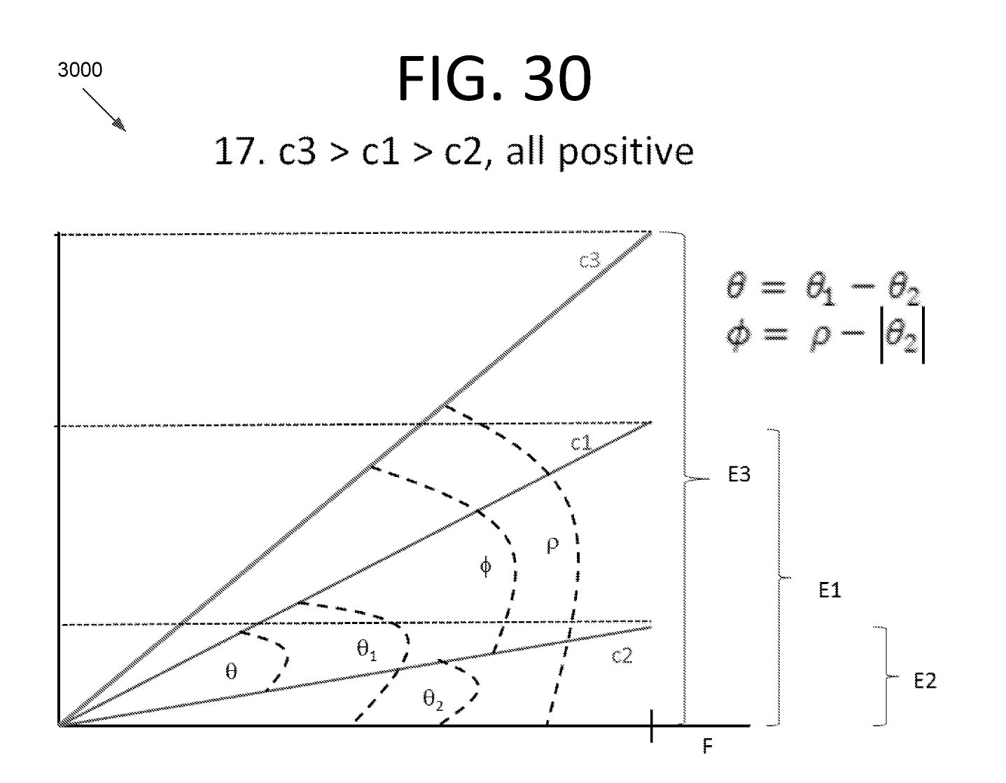

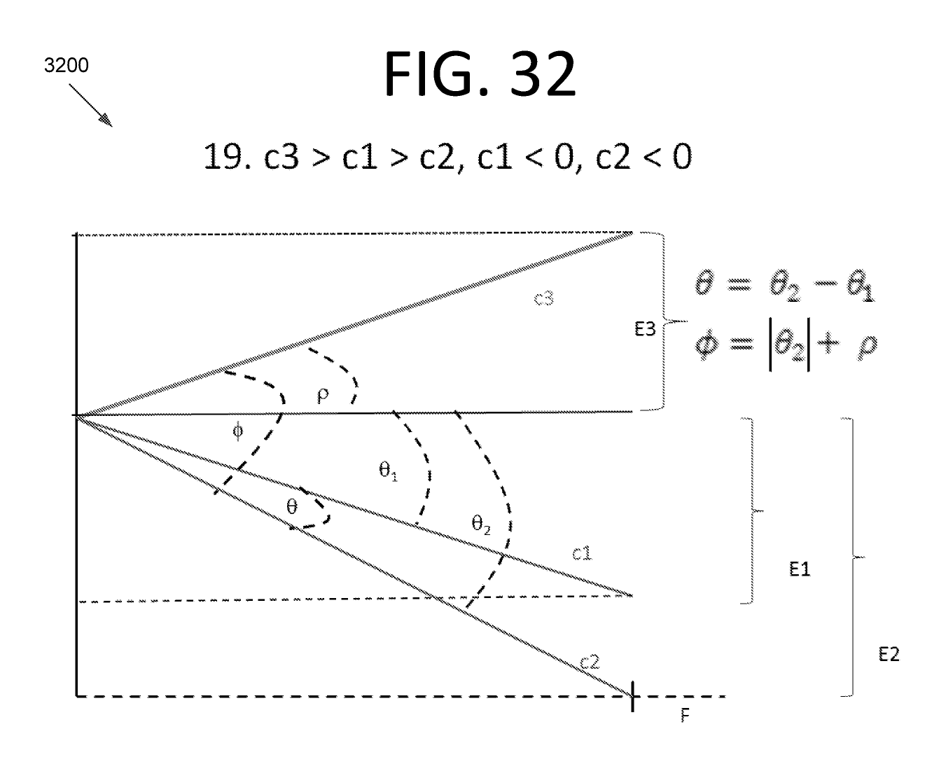

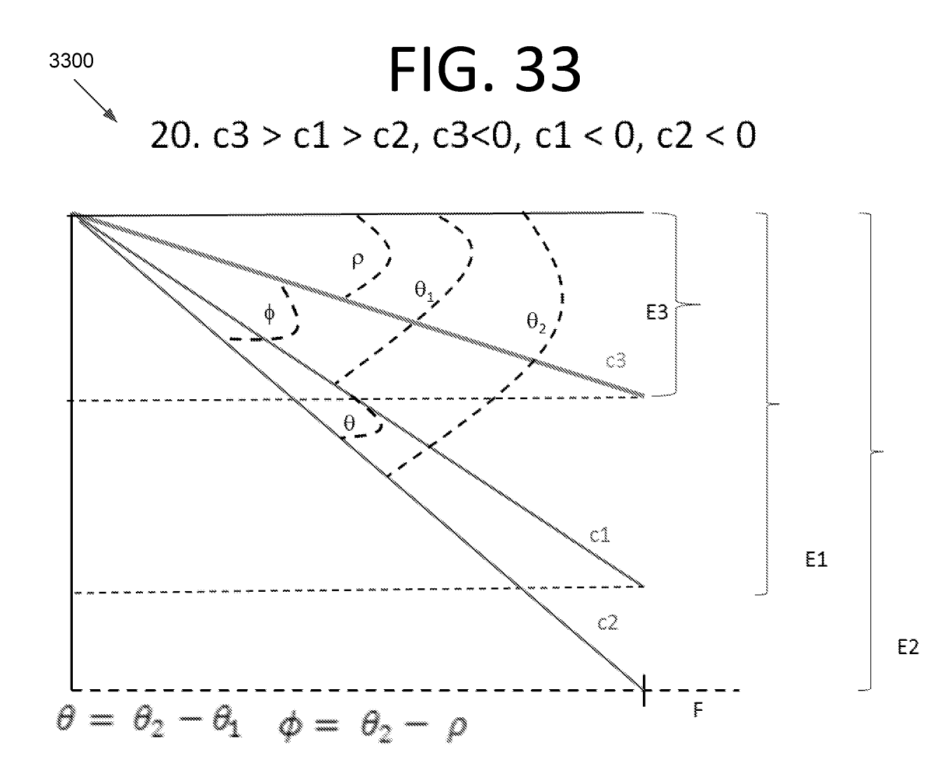

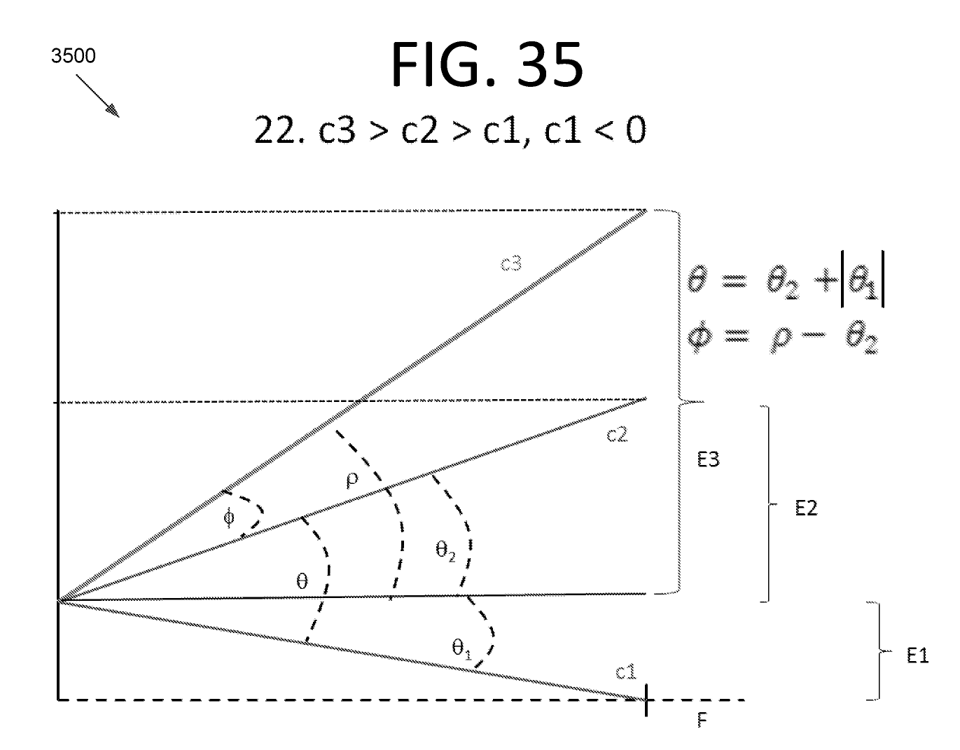

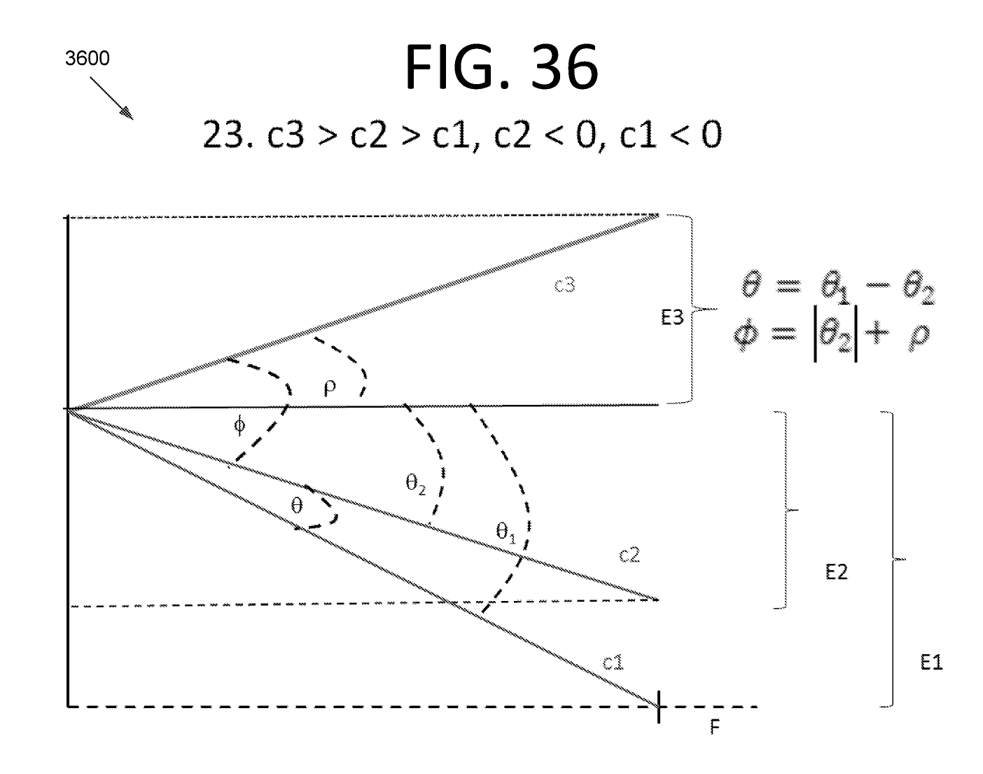

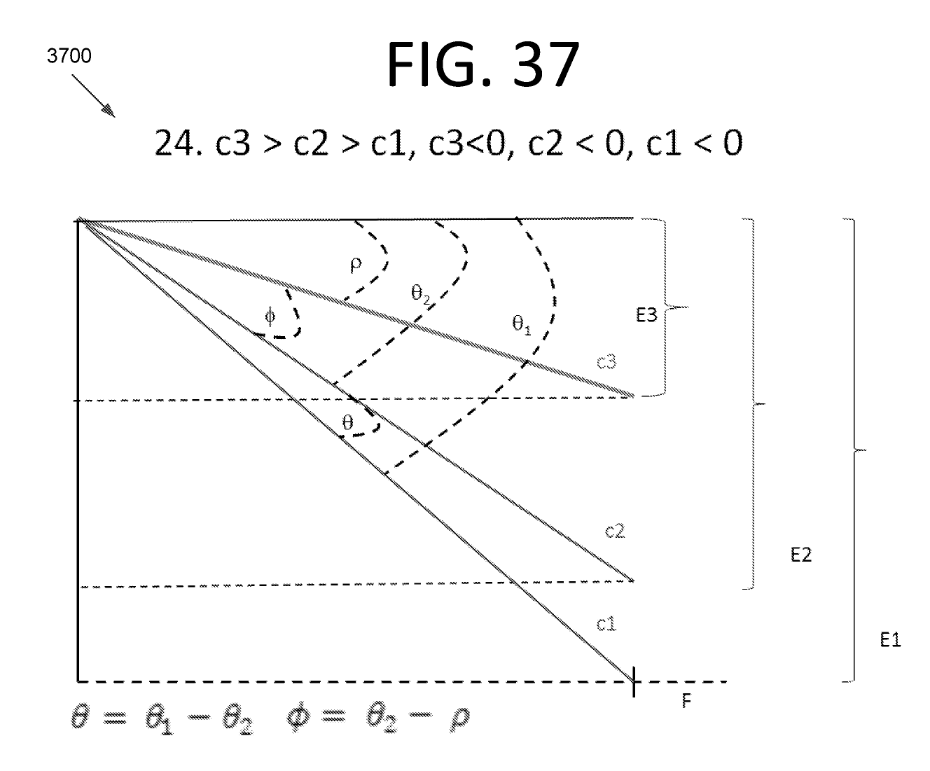

E1 1301, E2 1302, E3 1303, F 1304, and the other variable relationships are shown in FIGS. 14-37.

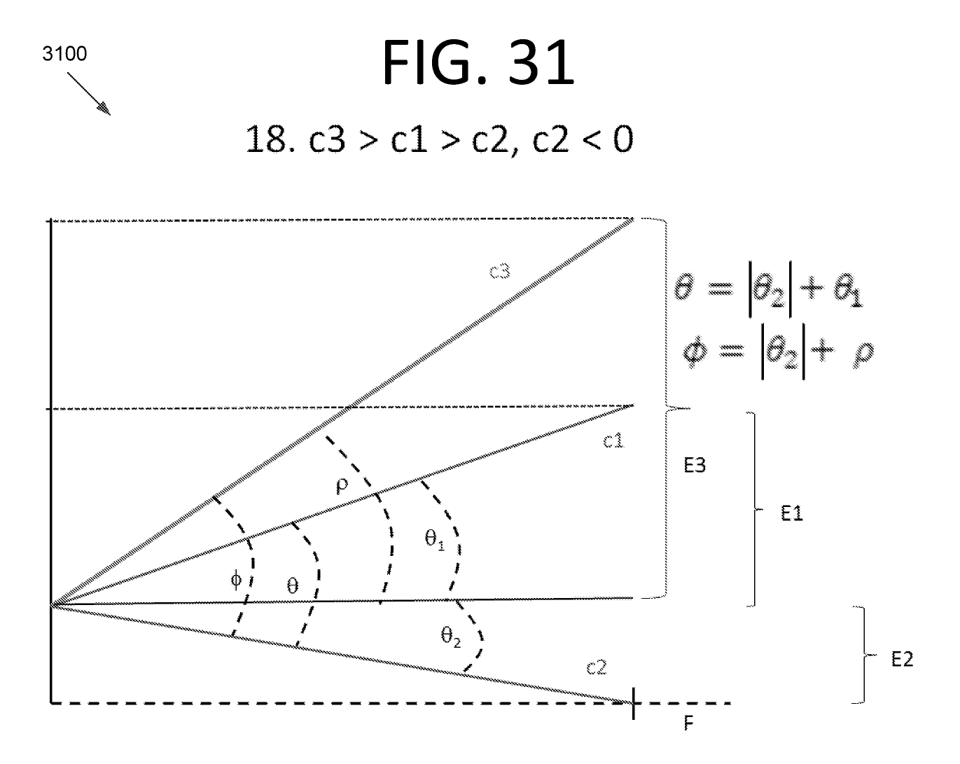

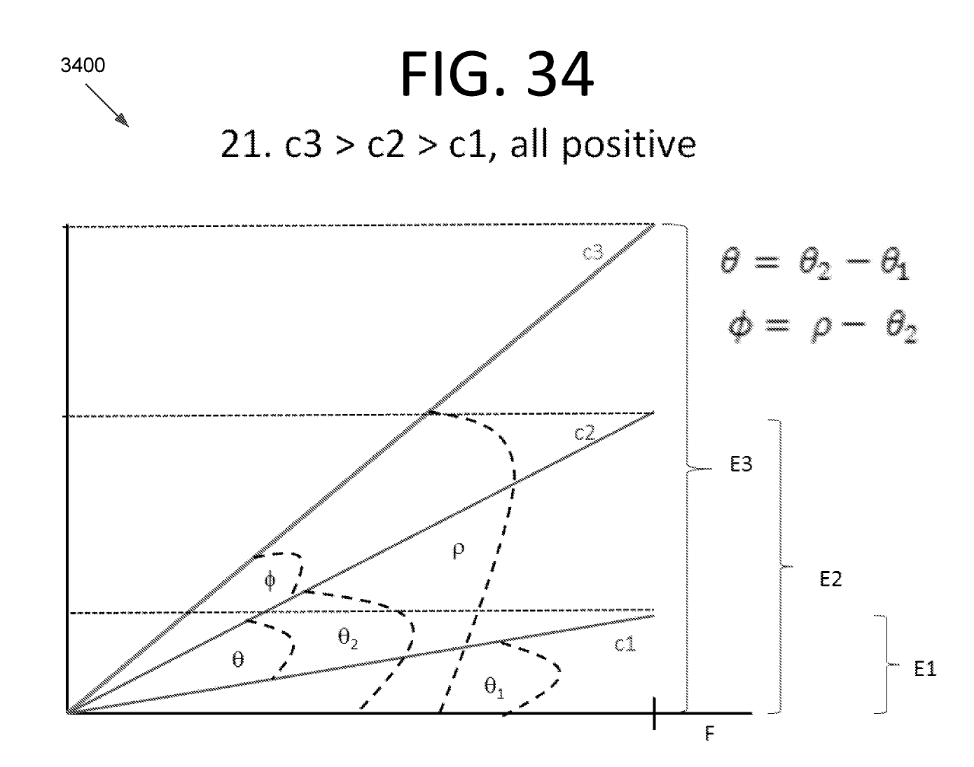

For instance, case 21 (c₃>c₂>c₁) applies to the 8-bit vector projection 3400 as shown in FIG. 34 and case 18 applies to the 7-bit vector projection 3100 as shown in FIG. 31. Other cases and projections are shown as indicated.

Probability and Scoring

The Huffman codes for secondary structures were weighted to provide each structure with an equal length code of probability in some embodiments. Therefore:

$${P}_{Huff - SS} = \frac{1}{2045} = 0.000489$$

Assuming that the space of 2045 codes covers all secondary structures, the probability of picking one at random equals 0.000488998. One secondary structure code is required for mRNA and miRNA, assuming fully independent structures for both.

$${P}_{pair} = {P}_{Huff - SS} * {P}_{Huff - SS} = \frac{1}{{2045}^{2}} = 2.391 \times {10}^{- 7} ≅ 0.000024 \%$$

becomes the probability of randomly selecting the correct secondary structures for a pair of miRNA:mRNA. If one knew the correct secondary structure for both molecules, only one code would be required and the probability of selecting the correct code would be equal to 1.

However, each code is very close to its adjacent code. Assuming that the user based his or her code selection on additional data, such as X-ray diffraction structures, thermodynamic analyses, precipitation array data, analogy to similar miRNA or mRNA, etc., the secondary structure code can be improved. Assume one wants to achieve a confidence level Q_{j,key}, where j={1, 2, . . . , 22} and key={1st key pair, 2nd key pair, 3rd key pair} such that the selected secondary structure code is within the vicinity of the closest secondary structure code to the actual miRNA or mRNA. That means that there are

N_{Huff-SS-miRNA}=(1−Q_{j,key})*2045

structures in the Q_{j,key} vicinity of the selected secondary structure code for the miRNA, and in the Q_{j,key} vicinity of the mRNA, there are

N_{Huff-SS-mRNA}=(1−Q_{j,key})*2045

structures.

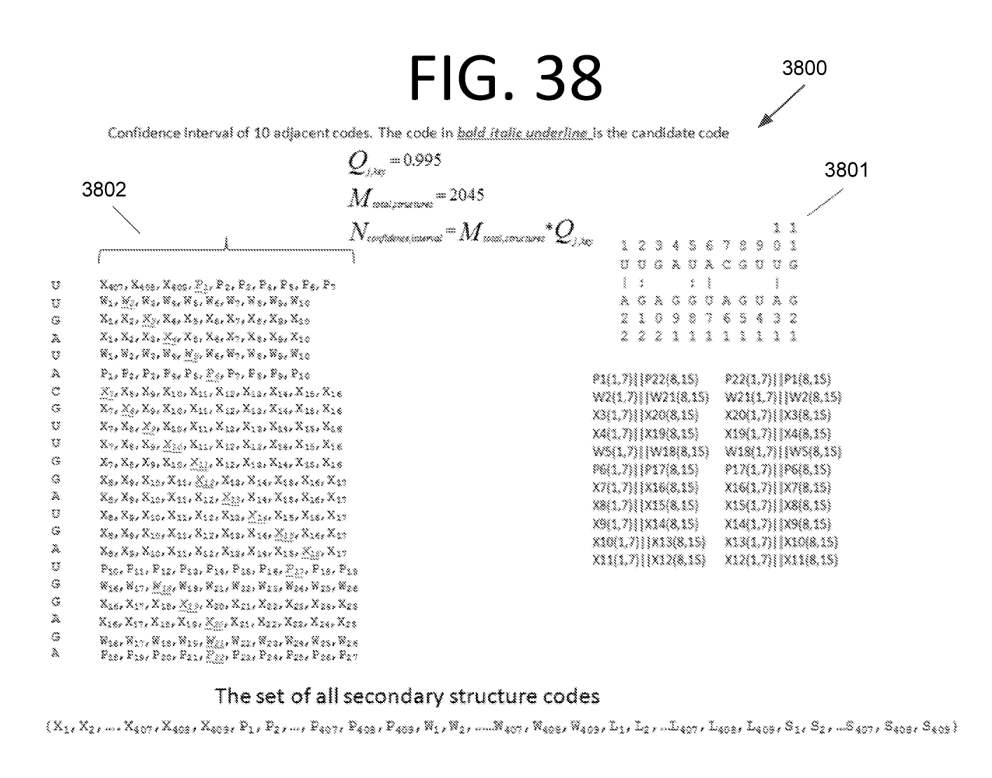

FIG. 38 depicts a scenario 3800 involving a folded let-7d sequence as shown in code 3801. In the first line of code, the bases in positions 1 and 22 are postulated to form a Watson-Crick pair. As shown in code 3802, there are 10 codes in the user-selected confidence interval: three codes to the left, and 6 codes to the right. Based upon externally-derived evidence, any one of those codes could be the correct secondary structure code for P1, with some probability p. In the second line of code, the bases in position 2 and 21 are postulated to form a G:U wobble pair over a user-selected confidence interval starting at one code to the left and extending 8 codes to the right, and so forth for each of the 22 bases.

Each code represents a “small” perturbation in the secondary sequence, so if a user has high confidence in the conformation of the bases in the sequence, the user can run the model with successive codes in the neighborhood of the selected code. As long as the user selects secondary structure codes in the neighborhood (from a probabilistic basis) of the correct code, the modeling output will be useful.

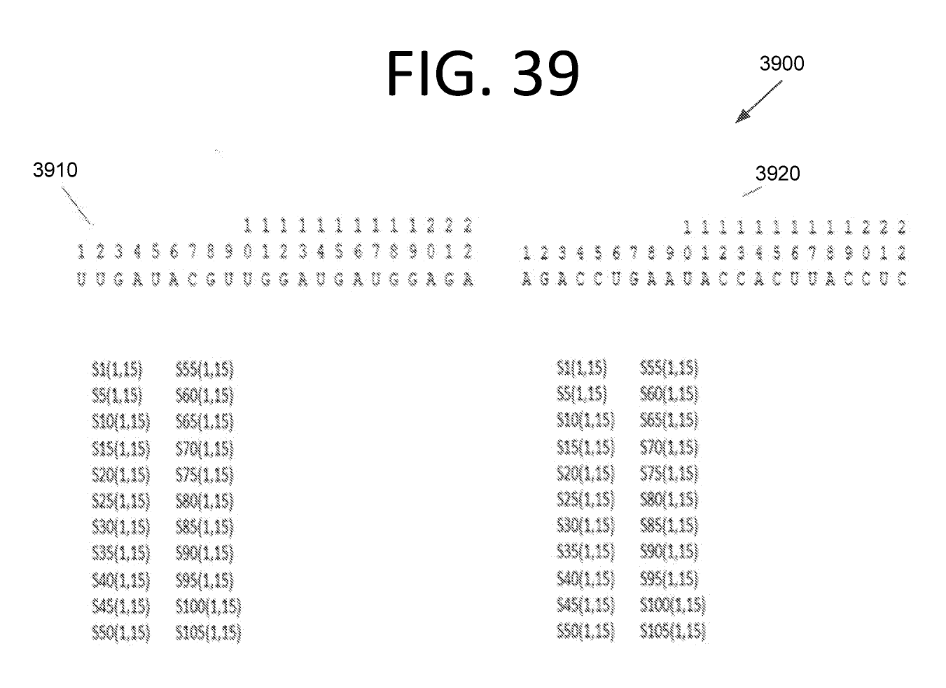

Assume that both mRNA and miRNA secondary structures are essentially linear and the only secondary structure codes of interest are the 409 S-codes. FIG. 39 provides one possible source programming 3900 for this example, using linear let-7d miRNA secondary structure coding 3910 and linear HMGA2-1091 mRNA secondary structure coding 3920. In this case, there is only one class of codes. If the secondary structure codes can be reduced to one of the 5 classes (in this case, the single stranded, unpaired class), then the number of structures in the confidence interval is as shown in Table 8.

TABLE 8
SEARCH SPACE WHEN ONLY ONE CLASS OF SECONDARY
STRUCTURE CODES IS REQUIRED

| | Number | | Number | | |
|---|---|---|---|---|---|
| | of | | of | | |
| | Structures | | Structures | | |
| | in | | in | | |
| | Confidence | | Confidence | Q _{j,key} for | |
| | Interval for | | Interval for | miRNA: | Search |
| Q _{j,key miRNA} | miRNA | Q _{j,key mRNA} | mRNA | mRNA pair | Space |
| 0.995 | 3 | 0.995 | 3 | 0.990025 | 9 |
| 0.99 | 5 | 0.99 | 5 | 0.9801 | 25 |
| 0.985 | 7 | 0.985 | 7 | 0.970225 | 49 |
| 0.98 | 9 | 0.98 | 9 | 0.9604 | 81 |
| 0.975 | 1 | 0.975 | 1 | 0.950625 | 121 |
| 0.97 | 13 | 0.97 | 13 | 0.9409 | 169 |
| 0.965 | 15 | 0.965 | 15 | 0.931225 | 225 |
| 0.96 | 17 | 0.96 | 17 | 0.9216 | 289 |
| 0.955 | 19 | 0.955 | 19 | 0.912025 | 361 |
| 0.95 | 21 | 0.95 | 21 | 0.9025 | 441 |
| 0.945 | 23 | 0.945 | 23 | 0.893025 | 529 |
| 0.94 | 25 | 0.94 | 25 | 0.8836 | 625 |
| 0.935 | 27 | 0.935 | 27 | 0.874225 | 729 |
| 0.93 | 29 | 0.93 | 29 | 0.8649 | 841 |
| 0.925 | 31 | 0.925 | 31 | 0.855625 | 961 |
| 0.92 | 33 | 0.92 | 33 | 0.8464 | 1089 |
| 0.915 | 35 | 0.915 | 35 | 0.837225 | 1225 |
| 0.91 | 37 | 0.91 | 37 | 0.8281 | 1369 |
| 0.905 | 39 | 0.905 | 39 | 0.819025 | 1521 |
| 0.9 | 41 | 0.9 | 41 | 0.81 | 1681 |

In Table 8, a certain confidence level for the secondary structure code is desired, and that confidence level for the miRNA and mRNA is specified by the columns Q_{j,key miRNA} and Q_{j,key mRNA}, respectively. The confidence level multiplied by the number of codes subtracted from the total number of codes equals the number of codes in the confidence interval. For a confidence level of 0.9, there are 41 secondary structure codes in the search space for miRNA and 41 secondary structure codes in the search space for mRNA. The entire search space is the product of 41×41=1681, for a confidence level of 0.9. Given a sufficient level of confidence in the secondary structure coding, a confidence of >98% can be achieved within as few as 25 simulation runs (all combinations of 5 miRNA and 5 mRNA codes to create a code space of 25 code combinations).

Model results should be verified against laboratory results. Laboratory results can then be used to update the secondary structure codebook and code selection.

Scoring Criteria for Downregulation

A probability mass function is associated with the decryption and detuning keys. For a series of decryption keys, {i}, there exists a probability mass function PMF for i, where pᵢ is the probability that decryption key dᵢ is in the scoring range, as described below. As an initial condition, PMF for the 13 keys may be demonstrated in this embodiment as:

PMF={2⁻¹,2⁻²,2⁻³, . . . ,2⁻¹³}

The initial scoring criteria is to set a threshold filter such that θ<f*φ, where f is a scaling factor and it 0<f≦1, i.e., the let-7d comp angle is less than the let-7d anti angle times a scaling factor. Any cell meeting the criteria may have its value retained; otherwise, the value is set to 0.

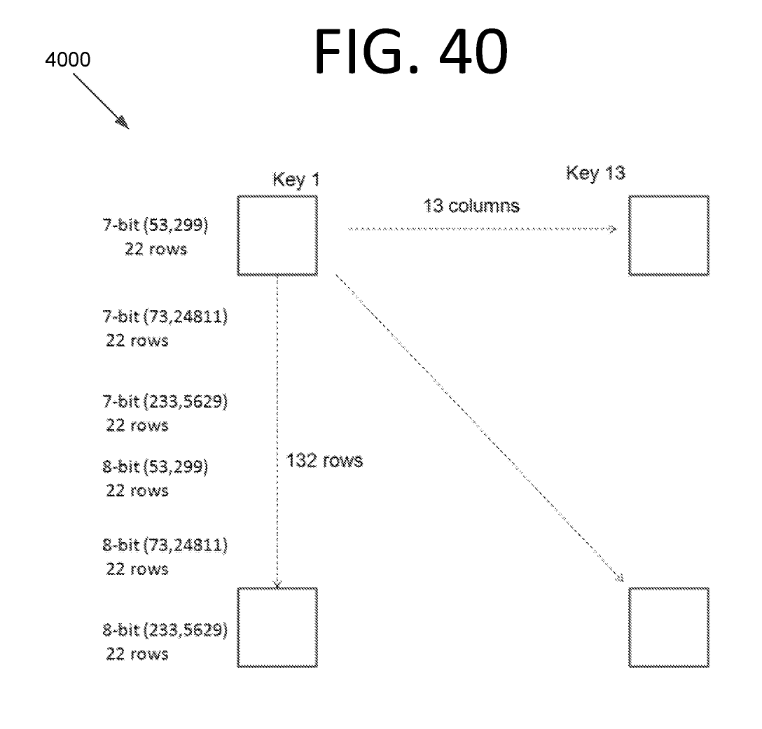

After filtering the data according to the threshold filter, the data is organized as shown in FIG. 40, which illustrates a 132×13 scoring matrix A 4000 for SVD analysis, according to an embodiment of the present invention.

Single Value Decomposition (“SVD”) analysis may be used to score the data. SVD may be used to identify the significant elements in large data sets. As such, SVD is widely used in the analysis of gene expression.

A_{132×13}=U_{132×132}S_{132×13}V_{13×13}^{T}

where U^{T}U=I; V^{T}V=I; the columns of U are orthogonal eigenvectors of AA^{T}, the columns of V are orthogonal eigenvectors of A^{T}A, and S is a diagonal matrix of singular values. In this embodiment, the matrix value

U_{132×132}×S_{132×13}

expresses the principal values of A. The score is the product of the most significant members of U and S

Scoreⱼ={U_{1,1}×S_{1,1}}ⱼ

In general, (S_{1,1})ⱼ>1 and (U_{1,1})ⱼ<0. The score is a direct correlation to the predicted level of downregulation by:

Kⱼ=2^{Score}^{ⱼ}

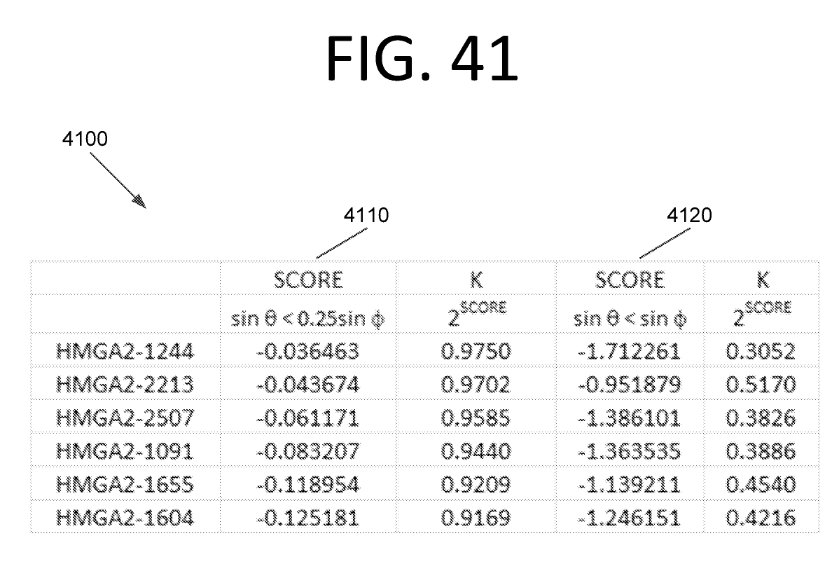

FIG. 41 illustrates a summary of the scoring 4100 for a downregulation prediction. The scores 4110 for scoring factor of f=0.25 are a narrower selection criteria than scores 4120 with a scoring factor of f=1. Kⱼ>0 indicates a prediction of upregulation or inconclusive model results.

SVD is an analysis tool that may be used in various ways, and this example is only intended to demonstrate the filtering of a single principle value representing the predicted regulatory effect of miRNA:mRNA seed:target interaction. The scoring matrix represents thousands of molecular interactions and can be mined for data in numerous ways.

Potential Benefits of the Information

The information yielded from the processes above may be used in some embodiments to identify potentially harmful interactions of miRNA onto mRNA that are not the intended binding target. The information may also be used to predict how miRNA may perform and may further provide a relatively low cost tool for evaluating the entire transcriptome for miRNA:mRNA seed-target interactions. Other non-coding RNA functions and other factors in RNA interference may also be evaluated.

Communications System Approach

The model discussed above evaluates miRNA:mRNA bindings one at a time. In vivo, multiple miRNA and mRNA sites exhibit a competitive form of regulation in which gene expression is broadly altered. For instance, downregulation of one protein can lead to upregulation of another protein. This activity can be broadly interpreted in terms of signal-to-interference noise ratio (“SINR”) between desired miRNA:mRNA interactions and competing miRNA:mRNA interactions. Intersymbol interference can be used as an analogy between multiple mRNAs being targeted by a single miRNA. As such, from a modeling standpoint, a multiple-input multiple-output (“MIMO”) communications model may be applied. Multiple miRNA and mRNA molecules can be treated as interferers and expression can be modeled on the basis of concepts like signal-to-noise ratio (“SNR”) and SINR. Casting the problem in terms of a communications model permits the tools of communications modeling to be adapted for analytical purposes.

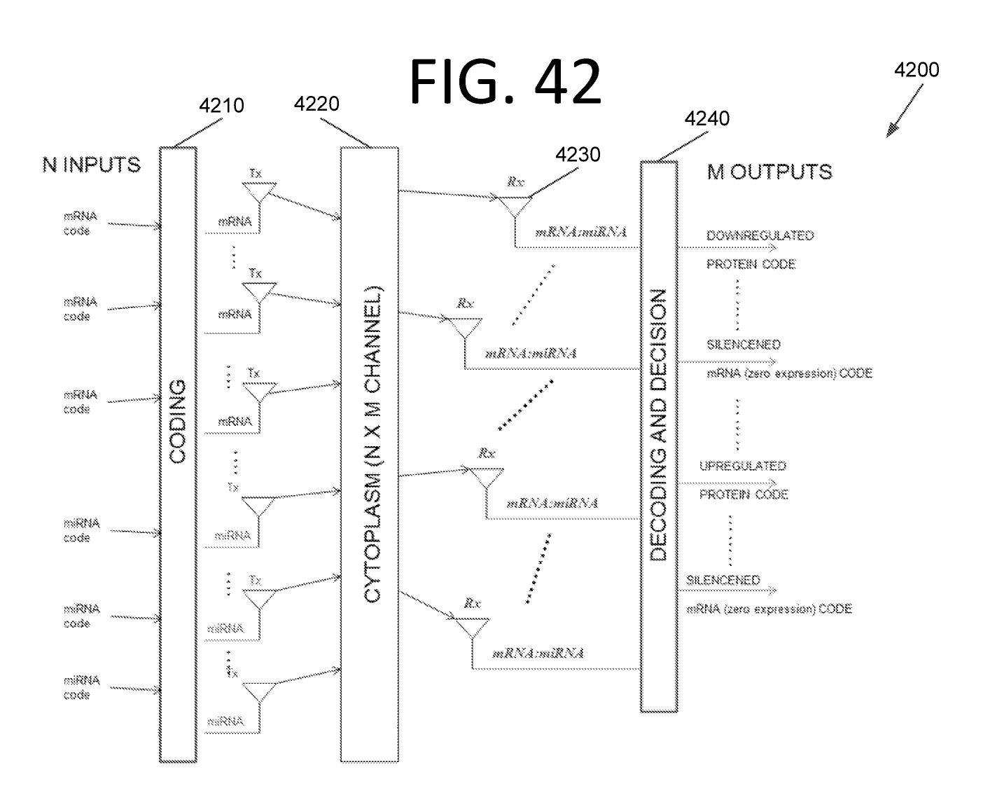

FIG. 42 illustrates multiple mRNA complexes and multiple miRNA complexes in a virtual Multiple Input Multiple Output (“MIMO”) channel 4200, according to an embodiment of the present invention. The source and channel coding of the mRNA and miRNA sequences occurs at 4210. These molecular species signal their presence in terms of atomic and molecular interactions that can be detected through analytical means, such as Nuclear Magnetic Resonance (“NMR”) spectroscopy, vibration spectroscopy such as Infrared (“IR”) and Raman spectroscopy, and binding assays to determine the terminal state of the interactions. Spectroscopic data from these species can be used to create new source codes, to create new channel codes, or to modify the primary and secondary codes

The signaling of the presence and molecular states is analogized by MIMO transmission over virtual antennas. These states are distorted by the channel 4420 (in the case of protein expression, this would occur in the cytoplasmic environment) in an analogous manner to the distortion of a signal through a wireless channel. Cytoplasmic channel distortion models can be created and coded. Pilot channels of cytoplasmic channel transmission characteristics can be modeled and used in pilot channel implementations of the model. Modeling can also include binding of miRNA to RISC and mRNA to ribosomal protein complexes.

The receiver function 4230 and decoding function 4240, in the case of protein expression, would occur at ribosomal protein complexes and P-bodies within the cytoplasm. Translation of the mRNA is analogous to the receiver decoding the received, distorted sequence with some error probability. The transmitter transmits code words for mRNA and miRNA. In this model, the receiver finds the code word for the received codes in its codebook for RNA-to-protein translation or mRNA silencing. There are error probabilities (bit error rates, symbol error rates, etc.) associated with these processes, and there can be an overlap of codebooks, i.e., some combination of translation and silencing may occur simultaneously. These processes are probabilistic and stochastic in nature.

The method steps performed in FIGS. 6-11 may be performed by a computer program product, encoding instructions for the nonlinear adaptive processor to perform at least the methods described in FIGS. 6-11, in accordance with an embodiment of the present invention. The computer program product may be embodied on a computer readable medium. A computer readable medium may be, but is not limited to, a hard disk drive, a flash device, a random access memory, a tape, or any other such medium used to store data. The computer program product may include encoded instructions for controlling the nonlinear adaptive processor to implement the methods described in FIGS. 6-11, which may also be stored on the computer readable medium.

The computer program product can be implemented in hardware, software, or a hybrid implementation. The computer program product can be composed of modules that are in operative communication with one another, and which are designed to pass information or instructions to display. The computer program product can be configured to operate on a general purpose computer, or an application specific integrated circuit (“ASIC”).

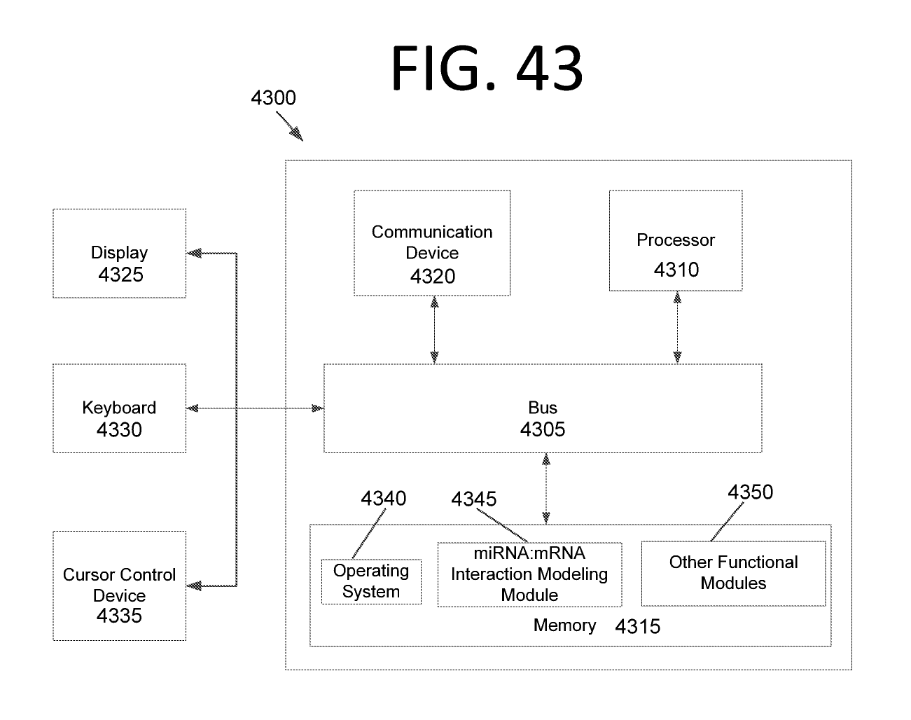

FIG. 43 illustrates a computing system 4300 for modeling miRNA interactions with mRNA, according to an embodiment of the present invention. System 4300 includes a bus 4305 or other communication mechanism for communicating information, and a processor 4310 coupled to bus 4305 for processing information. Processor 4310 may be any type of general or specific purpose processor, including a central processing unit (“CPU”) or application specific integrated circuit (“ASIC”). System 4300 further includes a memory 4315 for storing information and instructions to be executed by processor 4310. Memory 4315 can be comprised of any combination of random access memory (“RAM”), read only memory (“ROM”), flash memory, cache, static storage such as a magnetic or optical disk, or any other types of non-transitory computer-readable media or combinations thereof. Additionally, system 4300 includes a communication device 4320, such as a wireless network interface card, to provide access to a network.

Non-transitory computer-readable media may be any available media that can be accessed by processor 4310 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 4310 is further coupled via bus 4305 to a display 4325, such as a Liquid Crystal Display (“LCD”), for displaying information to a user. A keyboard 4330 and a cursor control device 4335, such as a computer mouse, are further coupled to bus 4305 to enable a user to interface with system 4300.

In one embodiment, memory 4315 stores software modules that provide functionality when executed by processor 4310. The modules include an operating system 4340 for system 4300. The modules further include a miRNA:mRNA interaction modeling module 4345 that is configured to model interactions between miRNA and mRNA using principles from cryptography. System 4300 may include one or more additional functional modules 4350 that include additional functionality.

One skilled in the art will appreciate that a “system” could be embodied as a personal computer, a server, a console, a PDA, a cell phone, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (“RAM”), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus, comprising:
a processor and memory storing computer program instructions, the computer program instructions configured to cause the processor to:
generate channel codes for ribonucleic acid (“RNA”) bases; and
code microRNA (“miRNA”) sequences and messenger RNA (“mRNA”) sequences using the channel codes.

2. The apparatus of claim 1, wherein the computer program instructions are further configured to cause the processor to program the coded miRNA and mRNA sequences with secondary structures, producing miRNA and mRNA binary sequences.

3. The apparatus of claim 2, wherein the computer program instructions are further configured to cause the processor to split the miRNA and mRNA binary sequences into smaller sequences.

4. The apparatus of claim 3, wherein the computer program instructions are further configured to cause the processor to encrypt the smaller sequences using an encryption algorithm.

5. The apparatus of claim 4, wherein the computer program instructions are further configured to cause the processor to decrypt the encrypted smaller sequences using decryption for the encryption algorithm.

6. The apparatus of claim 5, wherein the computer program instructions are further configured to cause the processor to project decrypted mRNA vectors onto decrypted miRNA vectors to produce error vector projections.

7. The apparatus of claim 6, wherein the computer program instructions are further configured to cause the processor to evaluate the error vector projections, and score and order results from the evaluation.

8. A computer-implemented method performed by a physical computing device, comprising:
generating, by a processor, channel codes for ribonucleic acid (“RNA”) bases; and
coding, by the processor, microRNA (“miRNA”) sequences and messenger RNA (“mRNA”) sequences using the generated channel codes.

9. The computer-implemented method of claim 8, further comprising:
generating, by the processor, a Huffman code dictionary for a set of secondary structure codes; and
distributing, by the processor, the Huffman code dictionary into multiple classifications of secondary structure.

10. The computer-implemented method of claim 9, further comprising:
programming, by the processor, the coded miRNA and mRNA sequences with the secondary structure, producing miRNA and mRNA binary sequences.

11. The computer-implemented method of claim 10, further comprising:
splitting, by the processor, the miRNA and mRNA binary sequences into smaller subsequences.

12. The computer-implemented method of claim 11, further comprising:
encrypting, by the processor, the smaller sequences with an encryption algorithm utilizing a plurality of different keys.

13. A computer-implemented method performed by a physical computing device, comprising:
decrypting, by a processor, a plurality of encrypted micro ribonucleic acid (“miRNA”) and messenger RNA (“mRNA”) subsequences.

14. The computer-implemented method of claim 13, further comprising:
projecting, by the processor, decrypted mRNA vectors onto decrypted miRNA vectors to produce error vector projections.

15. The computer-implemented method of claim 14, further comprising:
projecting, by the processor, the decrypted mRNA vectors onto a decrypted miRNA vector under evaluation.

16. The computer-implemented method of claim 14, further comprising:
projecting, by the processor, the decrypted mRNA vectors onto decrypted miRNA complementary sequence vectors.

17. The computer-implemented method of claim 14, further comprising:
projecting, by the processor, the decrypted mRNA vectors onto decrypted miRNA anti-complementary sequence vectors.

18. The computer-implemented method of claim 14, further comprising:
projecting, by the processor, complementary and anti-complementary calibration vectors onto an miRNA vector under evaluation.

19. The computer-implemented method of claim 14, further comprising:
evaluating, by the processor, the error vector projections from the decrypted mRNA vectors onto the decrypted miRNA vectors.

20. The computer-implemented method of claim 19, further comprising:
scoring and ordering, by the processor, results from the evaluated error vector projections.
